(19) United States
(12) Patent Application Publication
(10) Pub. No.: US 2024/0277038 A1
(43) Pub. Date: Aug. 22, 2024

(54) E-CIGARETTE CARTRIDGE

(71) Applicant: LEMEI XINGCHEN (SHENZHEN)BIOTECHNOLOGY CO., LTD., Shenzhen (CN)

(72) Inventor: Jihong LI, Yunxi (CN)

(73) Assignee: LEMEI XINGCHEN (SHENZHEN)BIOTECHNOLOGY CO., LTD., Shenzhen (CN)

(21) Appl. No.: 18/649,695

(22) Filed: Apr. 29, 2024

Related U.S. Application Data
(63) Continuation of application No. PCT/CN2022/129148, filed on Nov. 2, 2022.

(30) Foreign Application Priority Data
Nov. 5, 2021 (CN) 2021113102179

(51) Int. Cl. A24D 1/20; A24C 5/01; A24D 1/02; A24D 1/04; A24D 3/04; A24D 3/17; A24F 40/20; A24F 40/46; A24F 40/465; H05B 6/10

(52) U.S. Cl. CPC A24D 1/20; A24C 5/01; A24D 1/02; A24D 1/045; A24D 3/04; A24D 3/17; A24F 40/20; A24F 40/46; A24F 40/465; H05B 6/105

(57) ABSTRACT

The present invention relates to an e-cigarette cartridge. The e-cigarette cartridge is composed of a diversion section, a smoke-forming base section, a hollow section, and a filter tip section that are sequentially arranged in a packaging member. The present invention provides a plurality of structures of an e-cigarette cartridge, where the invention 1 discloses a structure of an e-cigarette cartridge commonly used for a resistance or electromagnetic smoking set with a plug-in central heating or a circumferential heating device. The inductor in the cartridge of the structure has a closed end and an open end. When heating is conducted with the plug-in smoking set, the heating plate or the heating needle of the smoking set can be smoothly inserted into the smoke-forming base material from the opening end without being blocked. In this case, the inductor can serve as a cooling plate so as to better transfer heat.

### CROSS-REFERENCE TO RELATED APPLICATIONS

The application claims priority to Chinese patent application No. 2021113102179, filed on Nov. 5, 2021, the entire contents of which are incorporated herein by reference.

### TECHNICAL FIELD

The present invention belongs to the field of heating technology for non-combustion e-cigarette, specifically involving an e-cigarette cartridge, especially one that is suitable for both plug-in heaters and surround-type electromagnetic induction heaters.

### BACKGROUND

Non-combustion heating cartridges were initially developed by international tobacco giants such as Philip Morris International. This type of e-cigarette is placed in heating devices, releasing nicotine and smoke from the cartridge through low-temperature baking. The temperature for such baking is around 300 degrees centigrade, much lower than the combustion temperature of traditional cigarettes, which is over 800 degrees centigrade. The carcinogenic substance content in the smoke of non-combustion cigarettes is 80% lower than that of ordinary cigarettes, reducing the intake of mutagens by smokers by 70%, and reducing the incidence of bronchitis and pneumonia by 46% and 36%, respectively. This significantly reduces the harm of tobacco products to the human body, and has led to a new trend in tobacco consumption.

Currently, there are mainly two heating methods for non-combustion heating cartridges. One method is to use heating needles or heating plates in smoking devices for plug-in electrical heating, while the other method utilizes electromagnetic induction for surround-type heating.

Electrical heating requires inserting heating needles or plates from smoking devices into smoke-forming products within the cartridge. The thrust generated during the insertion of the heating needle or plate into the cartridge causes displacement of the smoke-forming product or other functional sections within the cartridge. To solve this problem, existing technologies often employ isolation components at the rear end of smoke-forming products in cartridges to counteract the thrust generated during insertion. After heating, the heating needle or plate needs to be withdrawn from the cartridge. At this time, the smoke-forming product in the cartridge adheres to the heating needle or plate or enters the smoking device along with the heating needle or plate, making it extremely difficult to clean the smoking device. Prolonged accumulation of smoke-forming products in the smoking device can easily damage it, resulting in losses for consumers. Existing solutions to the above problems in current technology include covering and pasting sealing pieces at the end of smoke-forming products in the cartridge, or using stoppers with passages for heating plates or needles.

Electromagnetic induction heating requires the installation of an induction source consisting of electromagnetic coils in the smoking device and pre-setting sensors in the cartridge, wherein the sensor directly contacts the smoke-forming base material in the cartridge. The induction source generates an alternating electromagnetic field. When the cartridge is inserted into the smoking device, the alternating electromagnetic field induces heat generation in the sensor, generating eddy currents and/or hysteresis losses in the sensor, heating the smoke-forming base material, thereby generating smoke for the user to inhale. When heating in this way, the inductor is embedded in the cartridge, so there is no problem of thrust during insertion and withdrawal. However, the existing sensor is either a metal piece set at the center of the smoke-forming product or a coil set along the inner cylinder wall of the cartridge. When using metal pieces for heating, the heat is radiated from the inductor and gradually transferred from the center of the smoke-forming product to the periphery. The heat is gradually lost during the transfer, resulting in uneven heating, and it is easy to cause overheating at the center of the smoke-forming product and insufficient heating at the periphery. When using coils for heating, the situation is opposite to that of using metal pieces for heating. The heat acts on the smoke-forming product at the periphery first and then gradually transfers to the center. The heat is also gradually lost during the transfer, resulting in uneven heating. This can easily cause insufficient heating at the center of the smoking product and overheating at the periphery.

Given the differences in the structure of smoking devices, the structures of existing e-cigarette cartridges suitable for electric heating and those suitable for electromagnetic induction heating are not the same. Existing cartridges suitable for electric heating cannot be adapted to smoking devices suitable for electromagnetic heating, and cartridges suitable for electromagnetic heating cannot be adapted to smoking devices suitable for electric heating. Since electromagnetic induction heating does not have the problem of insertion and withdrawal during electric heating, electromagnetic induction is expected to replace electric heating as the mainstream in the future. However, at the current stage, most consumers use electric-heating smoking devices, while a small portion of consumers use electromagnetic-induction smoking devices. Hence, there is an immediate necessity to offer an e-cigarette cartridge capable of seamlessly fitting into both categories of smoking devices. This would enable users with either type of smoking device to utilize it effectively.

### SUMMARY

The purpose of the present invention is to address the shortcomings of the prior art by providing an e-cigarette cartridge that is suitable for both plug-in heaters and surround-type electromagnetic induction heaters.

### Explanation of Technical Terms in the Present Invention:

Far end: It is a relative concept, specifically referring to one end of the cartridge that is distant from or not close to the user's mouth during use.
Near end: It is corresponding to the far end, specifically referring to one end of the cartridge that comes into contact with the user's mouth during use.
Attaching: It refers to a tight contact between two components, achieved by the elasticity or frictional force between them to ensure one component closely adheres to the other.
Gluing: It refers to connecting two components together through adhesive.
Inner cylinder wall: It specifically refers to the inner cylinder wall of the packaging member consisting the paper cylinder, corresponding to the outer wall of the cylinder or the wall of the outer cylinder.
Sheet material: It refers to a material with a length much greater than its thickness, and with a certain width of a specific value or smoothly varying within a certain range.
Cylindrical material: It refers to a material with two parallel and identical end faces connected by a curved surface.
Folding: It refers to continuously applying force along a straight line on the material surface to deform it into a certain angle
Bending: It refers to continuously applying force along a specific curved surface to deform the material into a shape with at least one arc.
Flexible sheet material: It refers to a sheet material with certain flexibility, capable of withstanding bending, folding, or other deformations without fracturing.
Longitudinal section: It refers to a plane section formed by cutting the cartridge along the centerline of the sheet or cylindrical material forming the inductor.
Transverse section: It refers to a section formed by cutting the cartridge along the plane parallel to the two end faces of the packaging member.
Serrate shape: It refers to a shape with serrated tips formed by continuous folding.
Wavy shape: It refers to a shape resembling a wave line formed by connecting multiple arcs through continuous bending.
Gear shape: It refers to a shape resembling a gear formed by connecting multiple trapezoids of the same size and shape.
Door frame shape: It refers to a shape resembling a door frame enclosed by three lines, with adjacent lines set at right angles.
The height of the inductor: It refers to the maximum distance covered by the inductor along the axis of the cartridge in the cartridge.

The present invention is realized through the following technical solutions:

### Invention 1:

An e-cigarette cartridge composed of a diversion section, a smoke-forming base section, a hollow section, and a filter tip section that are sequentially arranged in a packaging member.

The said packaging member is a hollow paper cylinder designed to encase the diversion section, smoke-forming base section, hollow section, and filter tip section. The packaging member is made of paper material that can withstand temperatures of 100-300° C. without deformation or generating odors. The length of the packaging member ranges from 25-60 mm, with an outer diameter of 5.5-8 mm and a thickness of 0.05-2 mm. The packaging member is prefabricated using a rolling machine. A piece of tipping paper of the same length as the packaging member may be used to wrap around the outer cylinder wall of the packaging member to enhance aesthetics or to display product information.

The said diversion section is positioned at the far end of the packaging member and is formed by the inner cylinder wall of the packaging member and the first separation material. It serves to create a certain space between the far end of the cartridge and the interior surface of the smoking device to facilitate airflow, preventing tight contact between the far end of the cartridge and the internal surface of the device, which could cause excessive suction resistance and the transfer of oil ingredients from the smoke-forming product to the device. Optionally, several ventilation holes may be set through the cylindrical wall of the diversion section to further reduce suction resistance and provide multiple airflow paths.

The length of the diversion section within the cartridge can be designed to be 0.5-6 mm, preferably 1-4 mm, and more preferably 1 mm.

The said first separation material is attached or glued to the inner cylinder wall of the packaging member, separating the diversion section from the smoke-forming base section. It not only separates the diversion section from the smoke-forming base section but also acts as a barrier or seal for the smoke-forming base section to prevent it from falling off. Additionally, it features tiny air holes to provide air passage. During filling, if the component is attached, since there is no sealed connection between it and the inner cylinder wall of the packaging member, air holes may be omitted, requiring only high-permeability shaped paper to provide air passage. If the component glued, with no gap between the component and the inner cylinder wall, perforation is necessary to provide air passage. If there is a gap left between the first separation material and the inner cylinder wall of the packaging member, air holes may also be added to the first separation material, depending on actual needs.

The thickness of the first separation material ranges from 0.1-3 μm, preferably 0.8-2 μm, and most preferably 1.05 μm.

The said smoke-forming base section is filled with smoke-forming material and an inductor. The smoke-forming material, which constitutes the basis for producing smoke, consists of particles made from tobacco and/or non-tobacco plants. The said tobacco particles are obtained by grinding and pelletizing flue-cured, air-dried, sun-dried, burley, and other flavored tobacco leaves or tobacco shreds. The said non-tobacco particles are obtained by grinding and pelletizing roots, stems, leaves, flowers, fruits, or seeds of plants other than tobacco.

The length of the smoke-forming base section is 10-20 mm, preferably 12-16 mm, and more preferably 15 mm.

The inductor is made by bending or folding continuous sheet or cylindrical magnetic conductive material at least once, forming a partially enclosed geometric shape in the longitudinal section of the inductor in the e-cigarette; the said inductor has one end portion and two leg portions; the closed end of the inductor is the end portion, and the two open side-portions are the leg portions; the said inductor is placed within the smoke-forming base section and surrounded by it; due to the inductor's non-closed geometric shape within the smoke-forming base section, it is preferable that the longitudinal section of the inductor forms a “>” shape, allowing the interior space of the smoke-forming base section to be divided into four approximately equal-volume intervals labeled as a, b, c, and d (see FIG. 12), and this arrangement ensures that all four intervals can uniformly receive the heat transmitted by the inductor. When used in an electromagnetic induction-type heating device, the inductor generates heat evenly by interacting with the alternating magnetic field produced by the device's coils. When used in a plug-in electrically heated smoking device, the inductor efficiently transfers heat to the smoke-forming material as it has higher thermal conductivity. In both heating methods, the presence of the inductor ensures uniform heat distribution throughout the smoke-forming base section, thereby enhancing heating efficiency.

The hollow section is surrounded by the second separation material, the inner cylinder wall of the packaging member, and the filter tip section. The main function of the hollow section is cooling. Fragrance-enhancing or cooling particles can also be added to the hollow section. The length of the hollow section in the cartridge is 5-15 mm, preferably 8-12 mm, and most preferably 10 mm. Fragrance-enhancing particles are particles made by loading fragrances directly onto porous substrates, or they can be natural plant particles with aromatic components. Alternatively, they can be made from other harmless materials capable of absorbing heat and undergoing deformation. The hollow section may also include cooling or filtering elements as needed. Cooling elements can include hollow filter rods to trigger the Venturi effect for faster reduction of smoke temperature to the optimal level for inhalation.

The said second separation material is attached or glued to the inner cylinder wall of the packaging member and separates the hollow section from the smoke-forming base section. It prevents the smoke-forming material from entering the hollow section, thereby encapsulating or sealing the smoke-forming base material. Similar to the first separation material, the second separation material also features small air holes as pathways for smoke circulation. In designing the loading method, if the attaching method is used, because the second separation material is not sealed to the inner cylinder wall of the packaging member, air holes may not be necessary on the second separation material, and instead, high-permeability shaped paper alone may suffice to provide air passage. If the gluing method is employed and there is a sealed connection between the second separation material and the inner cylinder wall of the packaging member, then perforation is required to create air holes for smoke circulation. If there is space left between the first separation material and the inner cylinder wall of the packaging member, it depends on actual conditions whether air holes need to be added to the first separation material.

The thickness of the second separation material ranges from 0.1-3 μm, preferably 0.8-2 μm, and most preferably 1.05 μm.

Both the said first separation material and the second separation material are made of flexible sheet materials. The flexible sheet material is high-permeability shaped paper (3000CU-20000CU), perforated paper, perforated aluminum foil, perforated aluminum foil paper, perforated heat-resistant plastic film, perforated silicone film, perforated gel film, or perforated polylactic acid film. The longitudinal sections of the first and second separation materials are both “[” or “]” shaped. The first and second separation materials can be arranged along the axis of the cartridge in four ways: “][”, “[ ]”, “]]”, and “[[”. Among these options, the preferred arrangement is “]]”.

The filter tip section is placed at the proximal end of the packaging member and is made of material capable of filtering and cooling smoke. The main function of the filter tip section is to cool and filter the smoke. The filter tip may be made of acetate fiber or polylactic acid fiber. The filter tip section can be composed of a single solid core filter rod or a combination of a solid core filter rod and a hollow filter rod. When a single solid core filter rod is used, its length is 5-20 mm, preferably 6-12 mm, and most preferably 10 mm. When a combination of a solid core filter rod and a hollow filter rod is used, the length of the combined filter tip section is 10-20 mm, preferably 18 mm, with the solid core filter rod being 10 mm long and the hollow filter rod being 8 mm long.

The said hollow filter rod can also be equipped with flavor beads to enhance aroma.

Preferably, the said inductor is made by bending continuous magnetic conductive material once along a predetermined folding line, with the said folding line set at half the length of the magnetic conductive material in the longitudinal direction, resulting in a longitudinal section of the inductor shaped like “>” after folding.

Preferably, the said inductor is made by bending continuous magnetic conductive material once, with the said longitudinal section of the inductor shaped like “U”. When using this configuration, protrusions formed by outward bending or folding can also be placed on the two leg portions of the inductor. The inductor is supported on the inner cylinder wall of the packaging member through these protrusions.

Preferably, the said inductor is made by bending continuous magnetic conductive material once, resulting in a longitudinal section of the inductor forming an arc open on one side, with the arc having a radius of

$$π - \frac{11}{6} π ,$$

and a diameter ranging from 50% to 100% of the inner diameter of the packaging member. When using this configuration, protrusions formed by outward bending or folding can also be placed on the two leg portions of the inductor. The inductor is supported on the inner cylinder wall of the packaging member through these protrusions.

Preferably, the said inductor is made by folding continuous magnetic conductive material twice, with the said longitudinal section of the inductor shaped like a “door frame”.

Preferably, the said inductor is made by bending continuous magnetic conductive material an odd number of times, where the odd number is ≥3; the longitudinal section of the said end portion is serrate-shaped or wave-shaped, and the longitudinal sections of the leg portions is “ [symbol] ” (Chinese character “eight”)-shaped or “II”-shaped.

Regardless of the structural configuration of the inductor mentioned above, support parts can be added to the inductor, with the said support portions being formed by outward bending or folding of the ends of the two leg portions towards the opening of the inductor; the outermost ends of the two support portions are supported on the inner cylinder wall of the packaging member. The most preferred configuration for the support portions is to have obtuse angles between the support portions and the leg portions, although right angles and acute angles can also serve the same purpose. Furthermore, the connection between the support portions and the leg portions can be smoothly curved using an R angle.

The purpose of the design of the support portions and protrusions is primarily to reduce the contact area between the inductor and the inner wall of the packaging member, thereby minimizing the occurrence of overheating the paper packaging member due to the heating of the support portions during the heat transfer process, leading to burnt odors. Additionally, stabilizing the inductor with the support portions prevents displacement within the packaging member and increases the surface area of the inductor, thus enhancing heat dissipation and improving heat conduction efficiency.

When the longitudinal section of the inductor forms an arc with one side open, and the radius of the arc is

$$π - \frac{11}{6} π ,$$

the curved surface of the inductor can be tangent to the inner cylinder wall of the packaging member, providing support. In this configuration, if protrusions are further added to the inductor, they can also serve as support, allowing the inductor to be supported on the inner cylinder wall of the packaging member through these protrusions. In both cases mentioned above, the support portions may not be necessary, or they can be extended to work in conjunction with the protrusions or the curved surface.

When the longitudinal section of the inductor forms a “U” shape and protrusions are added to the two leg portions of the inductor through outward bending or folding, the support portions may not be necessary, or they can be extended to work in conjunction with the protrusions or the curved surface.

Regardless of the structural configuration of the inductor, to ensure that the inductor remains within the smoke-forming base section, the height of the inductor is set to be less than or equal to the length of the smoke-forming base section. To ensure stable support of the inductor within the smoke-forming base section, the maximum distance between the two leg portions of the inductor is set to be less than or equal to the diameter of the packaging member. This maximum distance between the two leg portions of the inductor includes the thickness of the sheet material or the diameter of the cylindrical material used for the inductor itself. Furthermore, when the maximum distance between the two leg portions of the inductor is less than the diameter of the packaging member, it is convenient to set up support portions for loading. This is because, at this point, it only requires pushing the inductor into the packaging member, where the inductor will be supported by the support portions without the need for any additional auxiliary support means. If support parts are not set up, the inductor can still be used and serve the same purpose; however, during loading of the inductor, a positioning device is needed to position it in the packaging member, then smoke-forming material is filled into the packaging member while the positioning device is removed. When the maximum distance between the two leg portions of the inductor equals the diameter of the packaging member, pushing the inductor into the packaging member will cause the elasticity of the inductor to naturally wedge some parts or ends of the two leg portions against the inner wall of the packaging member, eliminating the need for support portions. In any of the above scenarios, protrusions can be chosen to be set up or not according to requirements.

It is preferable that both the said first separation material and the second separation material include an inner ring sealing portion and an outer ring mating portion. The inner ring sealing portion directly contacts the smoke-forming material and, together with the packaging member, wraps around the smoke-forming material. The outer ring mating portion is used to serve as a portion that contacts the inner cylinder wall of the packaging member in the attaching or gluing process. The said inner ring sealing portion and the outer ring mating portion are different components of a single flexible sheet material. The said inner ring sealing portion is the central part of the entire flexible sheet material and is circular. The diameter of the inner ring sealing portion equals or infinitely close to the diameter of the packaging member. The said outer ring mating portion is the portion of the single flexible sheet material other than the inner ring sealing portion. Furthermore, the outer ring mating portion, placed beyond the circumference of the inner ring sealing portion, is tightly attached or glued to the inner cylinder wall of the packaging member after being folded, presenting a smooth or wrinkled shape.

Furthermore, the said outer ring mating portion, before being folding, undergoes trimming to either entirely connect to the circumference of the inner ring sealing portion, forming a circular shape, continuous serrations, continuous waves, or continuous gears; or partially connect to the circumference of the inner ring sealing portion, forming multiple discontinuous protrusions. Trimming can reduce the volume of the outer ring mating portion on one hand and decrease the consumption of flexible sheet material on the other hand.

Furthermore, when the outer ring mating portion is entirely connected to the circumference of the inner ring sealing portion, forming a ring, it presents a wrinkled shape after the first or second separation materials are pushed in by the insertion rod and tightly attached or glued to the inner cylinder wall of the packaging member.

Furthermore, when the outer ring mating portion is entirely connected along the circumference of the inner ring sealing portion, and presents continuous serrate, wave, or gear shapes, the first or second separation material may appear wrinkled or smooth after being pushed in by the insertion rod and tightly attached or glued to the inner cylinder wall of the packaging member. This depends on the size of the trimmed part.

Furthermore, when the outer ring mating portion is partially connected to the circumference of the inner ring sealing portion, forming multiple discontinuous protrusions, it presents a notched appearance after the first or second separation materials are pushed in by the insertion rod and tightly attached or glued to the inner cylinder wall of the packaging member.

Preferably, for the said outer ring mating portion of the first separation material, the optimal choice is a continuous shape formed after trimming, which attached or glued to the inner cylinder wall of the packaging member without wrinkles, protrusions, or gaps.

Preferably, when the second separation material is pushed into the packaging member by the insertion rod and attached or glued in a predetermined position, several grooves can be set along the axial direction on the surface of the pushing rod. During the process of pushing the entire second separation material into the packaging member, the excess part of the outer ring mating portion would normally form wrinkles. However, due to the presence of the grooves, the excess part will be forced into the grooves under pressure, forming indentations between the outer ring mating portion and the inner cylinder wall of the packaging member. In the case of using either the attaching or gluing method, these indentations remain. The formed indentations can serve as pathways for airflow, regulating suction resistance and increasing air permeability. They can also help avoid or reduce perforation on the flexible sheet material constituting the second separation material.

Preferably, the ends of the leg portions of the said inductor is set facing the first separation material, and the said end portion facing the second separation material. The cartridge of this structure adapts to both resistive or electromagnetic plug-in central heating smoking devices and resistive or electromagnetic circumferential heating smoking devices. When using a plug-in heater, the opening between the two leg portions of the inductor can accommodate heating needles or heating plates inserted into the smoke-forming product. In this case, the inductor acts as a heat transfer medium, ensuring that heat is evenly distributed to all corners of the smoke-forming product section. When using an electromagnetic circumferential heater, the inductor acts as a heater to provide heat to the smoke-forming product, while ensuring that the heat generated is evenly transmitted to the smoke-forming product, thereby improving heating efficiency.

The end portion of the inductor is oriented towards the first separation material, and the ends of the leg portions are oriented towards the second separation material. The cartridge of this structure is exclusively used for resistive or electromagnetic circumferential heating smoking devices. The inductor acts as a heater to provide heat to the smoke-forming product, while ensuring that the heat generated is evenly transmitted to the smoke-forming product, thereby improving heating efficiency.

Preferably, the filter tip section consists solely of a solid-core filter rod, or is composed of a combination of a solid-core filter rod and a hollow filter rod, wherein the hollow filter rod and the solid core filter rod may be tightly connected or disconnected; at least one aerosol passage is provided on the hollow filter rod, and the total cross-sectional area of the aerosol passages is 30%-90% of the total cross-sectional area of the packaging member.

The filter tip section is preferably composed of a combination of a solid core filter rod and a hollow filter rod, with the hollow filter rod positioned on one side of the filter tip section near the hollow section. In this configuration, due to the presence of aerosol passages in the hollow filter rod, the smoke undergoes the Venturi effect as it passes through the aerosol passages in the filter tip section, rapidly lowering its temperature. The smoke, cooled by the hollow filter rod, then enters the solid core filter rod for further cooling and filtration before being inhaled by the user, so that the user experiences no sensation of heat on the lips during inhalation.

When the filter tip section consists only of a solid core filter rod, additional cooling elements can be added to the hollow section to ensure the cooling effect on the smoke. Similarly, additional filtering elements can be added to the hollow section to ensure the filtration effect on the smoke. The use of cooling and filtering elements are established solutions with existing technology and thus is not reiterated here.

The said magnetic conductive material is a material capable of converting electromagnetic energy into heat, specifically paramagnetic or ferromagnetic metals or metal alloys, preferably iron-nickel alloys, manganese-zinc ferrite materials, nickel-zinc ferrite materials, cobalt alloys, pure iron, or stainless steel. The cobalt alloy is preferably a cobalt-based high-temperature alloy, a rare earth-cobalt hard magnetic alloy, or a tungsten-cobalt alloy, and the stainless steel is preferably martensitic steel, ferritic steel, austenitic steel, or austenitic-ferritic (duplex) stainless steel.

The sheet magnetic conductive material is 0.5-4 mm wide and 0.01-0.2 mm thick, while the diameter of the cylindrical magnetic conductive material is 0.05-2 mm.

### Invention 2:

An inductor for e-cigarette cartridges, characterized in that the said inductor is produced through the following steps:

Select a continuous sheet or cylindrical magnetic conductive material, and determine the width and thickness of the sheet magnetic conductive material or the diameter of the cylindrical magnetic conductive material to meet the requirements; if the material does not meet the requirements, then the material is processed to meet the requirements. Specifically, the said sheet magnetic conductive material is required to be 0.5-4 mm wide, and 0.01-0.2 mm thick, and the cylindrical magnetic conductive material is required to have a diameter ranging from 0.05 to 2 mm.

In the case of using a sheet magnetic conductive material, the width of the magnetic conductive material can smoothly vary within a certain range, so that the two long sides of the magnetic conductive material form continuous serrations, waves, or gear shapes. Multiple arc-shaped or rectangular grooves can also be evenly set on both long sides of the magnetic conductive material.

In the case of using a cylindrical magnetic conductive material, continuous thread-like shapes can be formed on the surface of the magnetic conductive material by cutting, or multiple arc-shaped or rectangular grooves can be set on the magnetic conductive material.

Cut the continuous magnetic conductive material into preset lengths; the preset length is determined according to the length of the smoke-forming base section used, generally 1.5-4 times the length of the smoke-forming base material section.

Placing the cut magnetic conductive material into a mold and forming the predetermined shape of the inductor through folding and/or bending at least once; the said inductor has one end portion and two leg portions, with one closed end of the inductor being the end portion and the two open side-portions being the leg portions.

The ends of the two leg portions of the fabricated inductor can also be bent or folded outward to the opening of the inductor to form support portions, or protrusions bent or folded outward the opening of the inductor can be set on the two leg portions, or support portions or protrusions can be set simultaneously.

The said inductor is loaded into the packaging member of the cartridge using a loading device, and the part with the maximum width between the two leg portions, two support portions, or two protrusions of the inductor is wedged against the inner cylinder wall of the packaging member, and then smoke-forming base material is loaded into the packaging member to surround the inductor. The preferred loading device is a push-in type loading device, and during loading, it can be inserted from either the distal end or the proximal end.

The other aspects not mentioned in this invention are the same as those in the Invention 1 and thus is not reiterated here.

### Invention 3:

An e-cigarette cartridge composed of a diversion section, a smoke-forming base section, a hollow section, and a filter tip section that are sequentially arranged in a packaging member.

The said packaging member is a hollow paper cylinder designed to encase the diversion section, smoke-forming base section, hollow section, and filter tip section. The packaging member is made of paper material that can withstand temperatures of 100-300° C. without deformation or generating odors. The length of the packaging member ranges from 25-60 mm, with an outer diameter of 5.5-8 mm and a thickness of 0.05-2 mm. The packaging member is prefabricated using a rolling machine. A piece of tipping paper of the same length as the packaging member may be used to wrap around the outer cylinder wall of the packaging member to enhance aesthetics or to display product information.

The said diversion section is positioned at the far end of the packaging member and is formed by the inner cylinder wall of the packaging member and the first separation material. It serves to create a certain space between the far end of the cartridge and the interior surface of the smoking device to facilitate airflow, preventing tight contact between the far end of the cartridge and the internal surface of the device, which could cause excessive suction resistance and the transfer of oil ingredients from the smoke-forming product to the device. Optionally, several ventilation holes may be set through the cylindrical wall of the diversion section to further reduce suction resistance and provide multiple airflow paths. The length of the diversion section within the cartridge can be designed to be 0.5-2 mm, preferably 1 mm.

The said first separation material is attached or glued to the inner cylinder wall of the packaging member, separating the diversion section from the smoke-forming base section. It not only separates the diversion section from the smoke-forming base section but also acts as a barrier or seal for the smoke-forming base section to prevent it from falling off. Additionally, it features tiny air holes to provide air passage. During filling, if the component is attached, since there is no sealed connection between it and the inner cylinder wall of the packaging member, air holes may be omitted, requiring only highly permeable molded paper to provide air passage. If the component glued, with no gap between the component and the inner cylinder wall, perforation is necessary to provide air passage. The thickness of the first separation material ranges from 0.1-3 μm, preferably 0.8-2 μm, and most preferably 1.05 μm.

The said smoke-forming base section is filled with smoke-forming material. The smoke-forming material, which constitutes the basis for producing smoke, consists of particles made from tobacco and/or non-tobacco plants. The said tobacco particles are obtained by grinding and pelletizing flue-cured, air-dried, sun-dried, burley, and other flavored tobacco leaves or tobacco shreds. The said non-tobacco particles are obtained by grinding and pelletizing roots, stems, leaves, flowers, fruits, or seeds of plants other than tobacco. The length of the smoke-forming base section is 10-20 mm, preferably 12-16 mm, and more preferably 13 mm.

The hollow section is surrounded by the second separation material, the inner cylinder wall of the packaging member, and the filter tip section. The main function of the hollow section is cooling. Fragrance-enhancing particles can also be added to the hollow section. The length of the hollow section in the cartridge is 5-15 mm, preferably 8-12 mm, and most preferably 10 mm. Fragrance-enhancing particles are particles made directly from flavorings/fragrances or other particles containing aromatic ingredients. Cooling or filtering elements can also be set in the hollow section as needed. The said second separation material is attached or glued to the inner cylinder wall of the packaging member and separates the hollow section from the smoke-forming base section. This configuration prevents the smoke-forming material from entering the hollow section, thereby encapsulating or sealing the smoke-forming base material. Similar to the first separation material, the second separation material also features small air holes as pathways for smoke circulation. In designing the loading method, if the attaching method is used, because the second separation material is not sealed to the inner cylinder wall of the packaging member, air holes may not be necessary on the second separation material, and instead, high-permeability molded paper alone may suffice to provide air passage. If the gluing method is employed and there is a sealed connection between the second separation material and the inner cylinder wall of the packaging member, then perforation is required for smoke circulation. The thickness of the second separation material ranges from 0.1-3 μm, preferably 0.8-2 μm, and most preferably 1.05 μm.

Both the said first separation material and the second separation material are made of flexible sheet materials. The flexible sheet material is high-permeability shaped paper (3000CU-20000CU), perforated paper, perforated aluminum foil, perforated aluminum foil paper, perforated heat-resistant plastic film, perforated silicone film, perforated gel film, or perforated polylactic acid film. The longitudinal sections of the first and second separation materials are both “[” or “]” shaped. The first and second separation materials can be arranged along the axis of the cartridge in four ways: “][”, “[ ]”, “]]”, and “[[”. Among these options, the preferred arrangement is “]]”.

The filter tip section is placed at the proximal end of the packaging member and is made of material capable of filtering and cooling smoke. The main function of the filter tip section is to cool and filter the smoke. The filter tip may be made of acetate fiber or polylactic acid fiber. The length of the filter tip section in the cartridge is 5-20 mm, preferably 8-12 mm, and most preferably 10 mm. The said filter section is made of materials capable of filtering and cooling smoke, and is positioned at the proximal end of the packaging member; the filter tip section consists solely of a solid-core filter rod, or is composed of a combination of a solid-core filter rod and a hollow filter rod, wherein the hollow filter rod and the solid core filter rod may be tightly connected or disconnected; at least one aerosol passage is provided on the hollow filter rod, and the total transverse section area of the aerosol passages is 30%-90% of the total transverse section area of the packaging member.

The e-cigarette cartridges of the above structure do not have inductors, thus they are only suitable for resistive or electromagnetic plug-in central heating smoking devices.

When it is needed for smoking devices with electromagnetic circumferential heating, an inductor can be provided in the smoke-forming base section of the above-mentioned cartridge structure. The said inductor is a closed geometric structure made by bending or curving continuous sheet or cylindrical conductive magnetic conductive materials; the inductor is placed in the smoke-forming material and surrounded by it. The said geometric structure can be elliptical, rectangular, triangular, or other irregular closed loop structures. Given the inductor being a closed geometric structure, the inductor can also be prefabricated in one step through a mold.

With the inductor provided, the cartridge of this structure can be used for electromagnetic circumferential heating smoking devices. Since the inductor is designed as a closed geometric structure, heating needles or plates cannot be inserted into the cartridges in resistive or electromagnetic plug-in central heating smoking devices. Therefore, this type of cartridge structure is only suitable for devices with circumferential heating and not for inset-type heating devices.

The said magnetic conductive material is a material capable of converting electromagnetic energy into heat, specifically paramagnetic or ferromagnetic metals or metal alloys, preferably iron-nickel alloys, manganese-zinc ferrite materials, nickel-zinc ferrite materials, cobalt alloys, pure iron, or stainless steel. The cobalt alloy is preferably a cobalt-based high-temperature alloy, a rare earth-cobalt hard magnetic alloy, or a tungsten-cobalt alloy, and the stainless steel is preferably martensitic steel, ferritic steel, austenitic steel, or austenitic-ferritic (duplex) stainless steel. The sheet magnetic conductive material is 0.5-4 mm wide and 0.01-0.2 mm thick, while the diameter of the cylindrical magnetic conductive material is 0.05-2 mm.

The said first separation material and the second separation material each comprise an inner ring sealing portion and an outer ring mating portion, wherein the said inner ring sealing portion and the said outer ring mating portion are different components of a single flexible sheet material; the said inner ring sealing portion is the central portion of the single flexible sheet material and is circular, and the diameter of the inner ring sealing portion=the inner diameter of the packaging member; the outer ring mating portion is the portion of the single flexible sheet material other than the inner ring sealing portion; the flexible sheet material is high-permeability shaped paper (3000CU-20000CU), perforated paper, perforated aluminum foil, perforated aluminum foil paper, perforated heat-resistant plastic film, perforated silicone film, perforated gel film, or perforated polylactic acid film.

The method of setting the inductor and its specific shape differ from Invention 1, while the remaining aspects not discussed here remain consistent with Invention. Therefore, further elaboration on these aspects is omitted.

The inductor in this invention is fabricated using the following method:

Select a continuous sheet or cylindrical magnetic conductive material, and determine the width and thickness of the sheet magnetic conductive material or the diameter of the cylindrical magnetic conductive material to meet the requirements; if the material does not meet the requirements, then the material is processed to meet the requirements. Specifically, the said sheet magnetic conductive material is required to be 0.5-4 mm wide, and 0.01-0.2 mm thick, and the cylindrical magnetic conductive material is required to have a diameter ranging from 0.05 to 2 mm.

In the case of using a sheet magnetic conductive material, the width of the magnetic conductive material can smoothly vary within a certain range, so that the two long sides of the magnetic conductive material form continuous serrations, waves, or gear shapes. Multiple arc-shaped or rectangular grooves can also be evenly set on both long sides of the magnetic conductive material.

In the case of using a cylindrical magnetic conductive material, continuous thread-like shapes can be formed on the surface of the magnetic conductive material by cutting, or multiple arc-shaped or rectangular grooves can be set on the magnetic conductive material.

Cut the continuous magnetic conductive material into preset lengths; the preset length is determined according to the length of the smoke-forming base section used, generally 1.5-4 times the length of the smoke-forming base material section.

Place the cut magnetic conductive material into a mold and form the desired shape of the inductor through folding and/or bending. Then the ends of the magnetic conductive material of the fabricated inductor are tightly joined together to create a closed geometric shape.

During usage, the fabricated inductor is loaded into the packaging member of the cartridge via a loading device, followed by filling the packaging member with smoke-forming material so that the inductor is entirely surrounded by the smoke-forming material. The loading device preferably is a push-in type, allowing insertion either from the far end or the proximal end. The said push-in loading device ensures that the inductor does not deform during the loading process.

Compared to existing technologies, the present invention offers the following advantages:
1. The present invention provides various structures for e-cigarette cartridges. Invention 1 discloses a structure applicable to both resistive or electromagnetic plug-in central heating smoking devices and resistive or electromagnetic circumferential heating smoking devices. In these structures, the inductor in the cartridge is designed with one end closed and the other end open, with the open end facing towards the far end of the cartridge. When used with plug-in smoking devices, the heating plates or needles can smoothly insert into the smoke-forming material through the open end. In this scenario, the inductor can serve as a heat sink for better heat transfer. When used with circumferential heating smoking devices, the inductor functions as an induction heating component to heat the smoke-forming product. This invention resolves the inconvenience of users needing to switch between smoking devices, which arises from the inability of existing cartridges to accommodate both insect-type and circumferential heating devices.
2. Invention 1 designs the inductor in a specific structure. When the preferred structure is “>” shaped, the inductor divides the smoke-forming base section into four nearly equal-sized zones. Each zone receives heat more evenly from the inductor, resulting in more even heat on the smoke-forming material and more thorough carbonization.
3. Invention 1 also discloses a technical solution where the open end of the inductor faces towards the proximal end of the cartridge, suitable for resistive or electromagnetic circumferential heating smoking devices.
4. Both Invention 1 and Invention 3 disclose a diversion section. When the cartridge is inserted into the smoking device, the said diversion section create a certain space between the far end of the cartridge and the interior surface of the smoking device to facilitate airflow, preventing tight contact between the far end of the cartridge and the internal surface of the device, which could cause excessive suction resistance and the transfer of oil ingredients from the smoke-forming product to the device. Several ventilation holes may be set through the cylindrical wall of the diversion section to further reduce suction resistance and provide multiple airflow paths.
5. The present invention encapsulates and confines the smoke-forming product by setting up the first and second separation materials. The area of the flexible sheet material of the first separation material is larger than the end surface area of the paper cylinder of the packaging member. It is fixed inside the paper cylinder by a cylindrical insertion rod, providing a more convenient, and reliable method compared to existing practices where sealing patches are directly adhered to the far end surface of the cartridge. This method eliminates the risk of incomplete sealing at the end surface of the packaging member while also leaving space for the diversion section. The second separation material, made of flexible sheet material, replaces the existing separation components in cartridge structures made of plastic, silicone, polylactic acid, or acetate fibers, significantly reducing production costs and making suction resistance easier to control. Additionally, using paper material for the separation materials meets environmental requirements.
6. When the second separation material specified in Invention 1 is loaded, several grooves can be set along the axial direction on the surface of the pushing rod. During the process of pushing the entire second separation material into the packaging member, the excess part of the outer ring mating portion would normally form wrinkles. However, due to the presence of the grooves, the excess part will be forced into the grooves under pressure, forming indentations between the outer ring mating portion and the inner cylinder wall of the packaging member. In the case of using either the attaching or gluing method, these indentations remain. The formed indentations can serve as pathways for airflow, regulating suction resistance and increasing air permeability. They can also help avoid or reduce perforation on the flexible sheet material constituting the second separation material.
7. Invention 1 also discloses various structures of the inductor. The said inductor, through the arrangement of support portions and protrusions, not only enhances stability to prevent displacement but also increases the heating surface area, thus improving thermal conductivity efficiency.
8. Invention 2 further discloses the method for fabricating the inductor in this invention, which is simple and practical, facilitating large-scale industrial production.
9. Invention 3 also discloses a cartridge structure suitable exclusively for plate- or needle-type insert-in heating smoking devices. This structure includes a division section and replaces conventional separation materials made of plastic or silicone with flexible sheet material, resulting in higher production efficiency, extremely low manufacturing costs, and better environmental compliance. Additionally, this invention also discloses a cartridge structure exclusively for electromagnetic circumferential heating smoking devices, featuring an inductor in a closed geometric structure. This design further ensures even heat transfer and enhances heat transfer efficiency.
10. Both the first and second separation materials of this invention are composed of an inner ring sealing portion and an outer ring mating portion. The inner ring sealing portion and the outer ring mating portion are different components of a single flexible sheet material. This structural design of the separation materials simplifies manufacturing processes, reduces costs, and consequently lowers the processing costs of the cartridge further.

### BRIEF DESCRIPTION OF DRAWINGS

FIGS. 1 to 11 are the structural drawings of e-cigarette cartridge structures of the present invention.

FIG. 12 is the structural drawing of the evenly divided smoke-forming base section of the present invention.

FIGS. 13 to 21 illustrate longitudinal sections of the inductor of the present invention.

FIG. 22 is the structural drawing of the first separation material or the separation material.

FIG. 23 illustrates the design of the first separation material or the second separation material in the cartridge.

FIGS. 24 to 32 are the drawings of the coupling modes between the cartridges of the present invention and different smoking devices.

In the FIGS.: 1—packaging member, 2—smoke-forming base section, 3—hollow section, 4—solid core filter tip, 5—inductor, 6—diversion section, 7—smoke-forming material, 8—first separation material, 9—second separation material, 10—hollow filter rod, 11—aerosol passage, 12—leg portion, 13—end portion, 14—support portion, 15—protrusion, 16—inner ring sealing portion, 17—outer ring mating portion, 18—indentation, 19—smoking device, 20—heating needle or heating plate, 21—induction coil.

### DETAILED DESCRIPTION OF THE EMBODIMENTS

The following provides further explanation of the present invention with reference to the accompanying drawings and examples. However, the protection scope of the present invention is not limited by the examples. Among them, Examples 1 to 18 are examples of Invention 1; Examples 19 to 21 are examples of Invention 2; Examples 22 to 24 are examples of Invention 3.

### Example 1

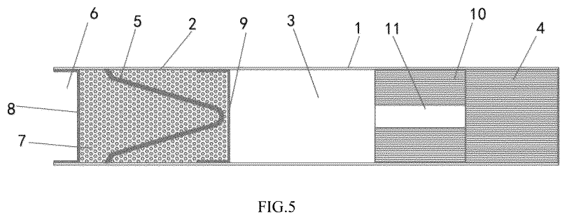

As shown in FIG. 5, this example is an electronic cigarette cartridge composed of a diversion section, a smoke-forming base section, a hollow section, and a filter tip section that are sequentially arranged in a packaging member. The said packaging member is a hollow paper cylinder. The length of the packaging member is 25 mm, with an outer diameter of 5.5 mm and a thickness of 0.05 mm. Therefore, the inner diameter of the packaging member can be calculated as 5.45 mm. The length of the diversion section is set to 2 mm; the length of the smoke-forming base section is set to 10 mm; the length of the hollow section is set to 5 mm; and the length of the filter tip section is set to 8 mm.

The diversion section is reserved at the far end of the packaging member, and is formed by the inner cylinder wall of the packaging member and the first separation material. The far end of the diversion section is open, and when the first separation material is inserted into the packaging member, the diversion section is naturally formed, with the first separation material attached to the inner cylinder wall of the packaging member, separating the diversion section from the smoke-forming base section.

The smoke-forming base section is filled with smoke-forming material and an inductor. The smoke-forming material consists of particles made from tobacco plants. Tobacco particles are obtained by grinding and pelletizing roasted tobacco, with a diameter ranging from 3 to 5 mm.

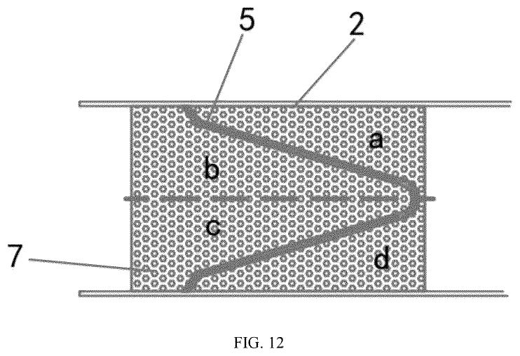

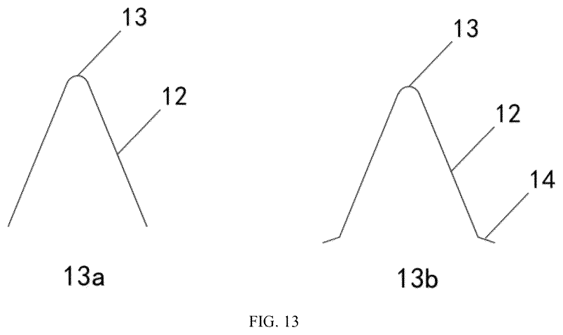

As shown in FIG. 13a, the said inductor is made of continuous sheet magnetic conductive material folded along a predetermined folding line. The said sheet magnetic conductive material is a thin iron-nickel alloy sheet, with a width of 0.5 mm and a thickness of 0.01 mm. The said folding line is located at the midpoint of the length direction of the magnetic conductive material, and the longitudinal section of the inductor formed after folding is “>” shaped. The closed end of the inductor formed by folding is the end portion, while the two open-side portions forming a sharp angle are the leg portions. The said inductor is placed in the smoke-forming material and surrounded by it. The end portion of the inductor is positioned near the second separation material, and the ends of the two leg portions are set on the inner cylinder wall of the packaging member to provide support. The height of the inductor is 8 mm, and the maximum distance between the two leg portions of the inductor is 5.45 mm. The sheet magnetic conductive material is rigid, and when it is folded to form the inductor, it exhibits elastic deformation recovery. Under this elastic force, the inductor stably supports itself on the inner cylinder wall of the packaging member. As shown in FIG. 12, the inductor divides the smoke-forming material in the packaging member into four intervals, labeled as a, b, c, and d, with roughly equal amounts of smoke-forming material in each interval.

The said hollow section is composed of the second separation material, the inner cylinder wall of the packaging member, and the filter tip section. The second separation material is attached to the inner cylinder wall of the packaging member, separating the hollow section from the smoke-forming base section. The hollow section acts as a cavity reserved within the packaging member, serving to buffer and particularly, cool down the smoke. The temperature of the smoke generated by heat, naturally decreases as it passes through the relatively long path formed by the hollow section. Depending on the cooling requirements, cooling elements may be added, or a hollow filter rod may be additionally provided within the hollow section to further assist in cooling. Alternatively, aromatic or cooling particles may be added to the hollow section. These aromatic particles can be loaded into the hollow section or applied by spraying onto the inner cylinder wall of the packaging member.

The said filter tip section is positioned at the proximal end of the packaging member and is composed of an acetate fiber filter rod, which filters and cools the smoke generated by the smoke-forming material, and makes it suitable for inhalation by the user. The filter tip section utilizes a solid core filter rod for individual filtration, thereby minimizing suction resistance.

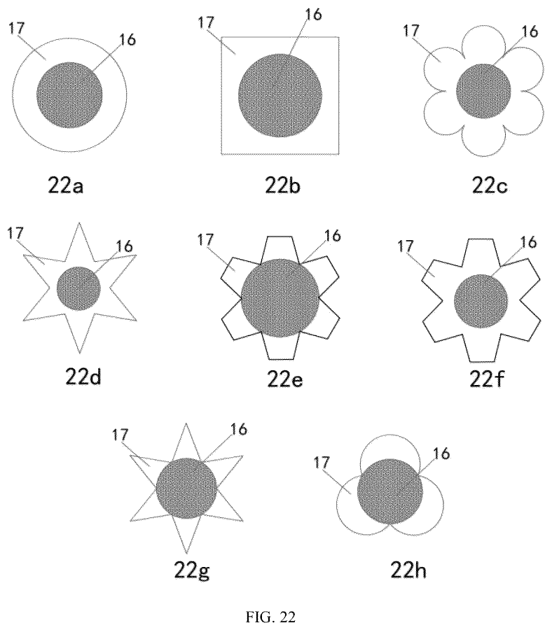

Both the first separation material and the second separation material include an inner ring sealing portion and an outer ring mating portion. The inner ring sealing portion directly contacts the smoke-forming material and, together with the packaging member, wraps around the smoke-forming material. The outer ring mating portion is used to serve as a portion that contacts the inner cylinder wall of the packaging member in the attaching or gluing process. The said inner ring sealing portion and the outer ring mating portion are different components of a single flexible sheet material, as shown in FIG. 22b. The said inner ring sealing portion is the central part of the entire flexible sheet material and is circular. The diameter of the inner ring sealing portion equals or infinitely close to the diameter of the packaging member. The said outer ring mating portion is the portion of the single flexible sheet material other than the inner ring sealing portion.

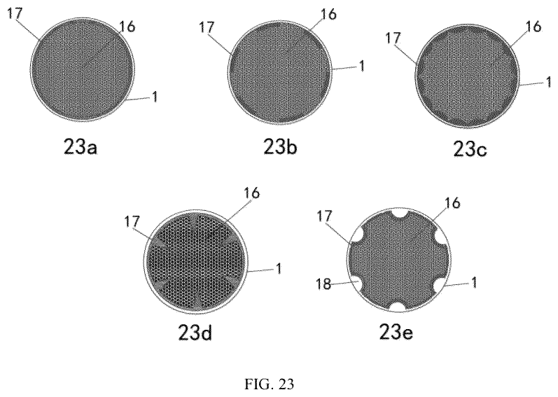

The said flexible sheet material is high-permeability shaped paper (3000CU-20000CU), and the longitudinal sections of both the first and second separation materials are “]” shaped. After being pushed into the packaging member by the insertion rod, the transverse sections of the first and second separation materials within the enclosure are as shown in FIG. 23c.

During production, the paper material, heated to 100-300° C. without deformation and emitting odors, is rolled into the packaging member using a rolling machine. Then the pre-cut second separation material is pushed into the specified position within the packaging member from its far end using an insertion rod. Next, the pre-bent inductor is pushed into the specified position within the packaging member from its far end using a pushing device. The prepared smoke-forming material is then loaded into the packaging member from its far end using a loading device. After that, the second separation section is pushed into the specified position within the packaging member from its far end using the insertion rod. Finally, after reserving the hollow section within the packaging member, the filter rod is inserted into the packaging member from the proximal end using a loading device. Additionally, decorative paper or patterned stickers can be applied to the exterior wall of the packaging member to meet aesthetic and commercial needs.

For a smoother connection, the present example also features a smoothed connection treatment for the end portion of the inductor. The longitudinal section of the inductor in the cartridge of this example is shown in FIG. 13a. This cartridge example is suitable for both electromagnetic induction heating smoking devices and plug-in electric heating smoking devices. In the case of an electromagnetic induction heating smoking device, the role of the inductor is to sense the alternating magnetic field generated by the electromagnetic coil in the smoking device after the cartridge is inserted, thereby generating heat to evenly heat the smoker-forming material. Forming the inductor into a “>” shape also enhances heat transfer. In the case of a plug-in electric heating smoking device, the heating needle is inserted into the cartridge and begins heating. Due to its higher thermal conductivity compared to the smoke-forming material, the inductor can evenly transfer heat to the smoke-forming material after being heated. Forming the inductor into a “>” shape facilitates easier insertion of the heating needle, eliminating resistance from the inductor when the heating needle is inserted into the cartridge. In both heating methods, the presence of the inductor ensures uniform heat distribution in the smoke-forming material within zone a, b, c and d of the smoke-forming base section, thereby enhancing heating efficiency.

In a more preferred example, support portions can also be formed at the ends of the legs of the inductor by bending, as shown in FIG. 13b. An inductor with support portions can be supported on the inner wall of the enclosure through these support portions. If the inductor is furnished with support portions, these structures can assist in holding the inductor against the inner cylinder wall of the packaging member.

### Example 2

The packaging member has a length of 60 mm, an outer diameter of 8 mm, and a thickness of 2 mm. Therefore, the inner diameter of the packaging component can be calculated as 6 mm. The length of the diversion section is set to 5 mm; the smoke-forming material section is set to 20 mm; the hollow section is set to 15 mm; and the filter tip section is set to 20 mm.

The said smoke-forming base section is loaded with smoke-forming material and an inductor. The said smoke-forming material consists of particles made from non-tobacco plants. The said non-tobacco particles are made by grinding and pelletizing roasted tobacco, with a diameter ranging from 2 to 3 mm.

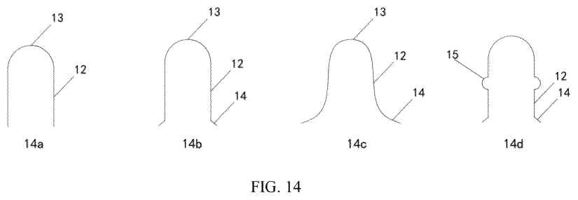

The said magnetic conductive material is cylindrical manganese-zinc ferrite material with a diameter of 0.05 mm. The longitudinal section of the inductor within the cartridge is shown in FIG. 14a. The said inductor is formed by bending continuous cylindrical magnetic conductive material once. The longitudinal section of the inductor is “U” shaped, with a height of 18 mm and a maximum distance of 3 mm between the two leg portions of the inductor.

The said filter tip section is positioned at the proximal end of the packaging member and consists of a combination of a solid core filter road and a hollow filter rod, both made from acetate fibers. The length of the solid core filter rod is 11 mm, and the length of the hollow filter rod is 9 mm. The total transverse section area of the aerosol passage in the hollow filter rod is 30% of the total transverse section area of the packaging member. The hollow filter rod is positioned on one side of the filter tip section near the hollow section. Due to the aerosol passage in the hollow filter rod, the smoke undergoes the Venturi effect as it passes through the aerosol passage in the filter tip section, rapidly reducing its temperature. The cooled smoke then enters the solid core filter rod for further cooling and filtration before being inhaled by the user, so that the user experiences no sensation of heat on the lips during inhalation.

The longitudinal section of the first separation material is “[” shaped, and the longitudinal section of the second separation material is “]” shaped. Both the first and second separation materials are made of perforated aluminum foil. As described in FIG. 22a, the outer ring mating portion of the first and second separation materials are circular. The transverse sections of the first and second separation materials within the packaging member after being pushed in by an insertion rod are shown in FIG. 23c, with the remainder being the same as in Example 1.

Due to the absence of support portions and protrusions, and with a distance of 3 mm between the two leg portions of the inductor, it is necessary to use a push rod with positioning function to load the inductor in this example. When the inductor is pushed into place within the packaging member, the smoke-forming material is then loaded, and at this point, the insertion rod is pulled out so that the axis of the inductor is aligned with that of the packaging member. Even if the axis of the inductor does not completely align with the axis of the packaging member, this deviation is acceptable as long as it does not impede the insertion of the heating needle or plate.

### Example 3

The leg portions of the inductor are equipped with protrusions bent or folded outwardly, to support against the inner cylinder wall of the packaging member. At this point, the maximum distance between the two leg portions of the inductor is the distance between the vertices of the two protrusions, which is 6 mm. According to needs, support portions can be made by bending outwardly the ends of the leg portions, with a distance of 6 mm between the outermost ends of the support portions. The longitudinal section of the inductor within the cartridge in this example is shown in FIG. 14d.

In this example, the inductor can also be equipped with support portions only (without protrusions), depending on needs. The structure of protrusions formed by folding are shown in FIG. 14b, while the structure formed by bending is shown in FIG. 14c. The remainder is the same as in Example 2.

### Example 4

The packaging member has a length of 45 mm, an outer diameter of 7.1 mm, and a thickness of 0.1 mm. Therefore, the inner diameter of the packaging member can be calculated as 7 mm. The length of the diversion section is set to 0.5 mm; the smoke-forming material section is set to 10 mm; the hollow section is set to 14.5 mm; and the filter tip section is set to 20 mm.

The said smoke-forming base section is loaded with smoke-forming material and an inductor. The said smoke-forming material consists of particles made from non-tobacco plants. The said non-tobacco particles are made by grinding and pelletizing cassava.

The said inductor is made by bending continuous magnetic conductive material once. The said magnetic conductive material has a width of 4 mm and a thickness of 0.2 mm, and it is made of nickel-zinc ferrite material. The longitudinal section of the inductor is an arc with one side open, and the radius of the arc is

$$π - \frac{11}{6} π .$$

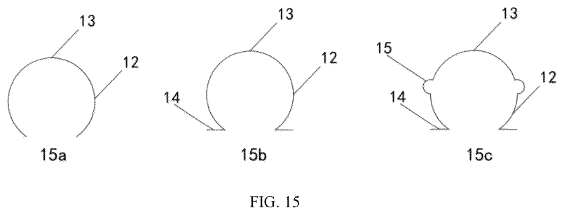

Since the longitudinal section of the inductor is an arc greater than a semicircle, the maximum distance between the two leg portions of the inductor is the diameter of this arc. The diameter of the said arc is 90% of the inner diameter of the packaging member, i.e., 6.3 mm. The height of the inductor is 6 mm. The longitudinal section of the inductor within the cartridge in this example is shown in FIG. 15a.

In this example, the maximum distance between the two leg portions of the inductor is 6.3 mm, while the inner diameter of the packaging member is 7 mm. Therefore, during loading, it is required to use an insertion rod with positioning function to load the cartridge while withdrawing the rod simultaneously, in a method as described in Example 2.

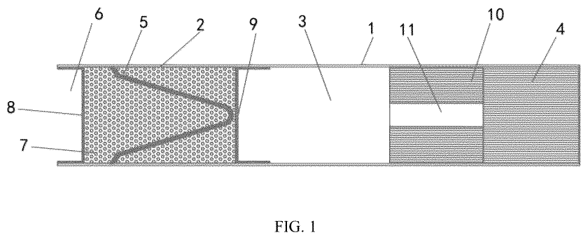

In this example, both the first and second separation materials are made of perforated paper, as shown in FIG. 1. In this example, the longitudinal section of the first separation material is “]” shaped, and the longitudinal section of the second separation material is “[” shaped. As illustrated in FIG. 22c, the outer ring mating portions on the first and second separation materials are trimmed into multiple continuous arcs, forming a shape resembling a flower. With this structure, after the separation materials (including the first and second separation materials) are pushed into the packaging member, the outer ring mating portions do not cause wrinkles on the inner cylinder wall of the packaging member, as shown in FIG. 23b. This structure reduces the size of wrinkles, thus helping to reduce suction resistance. The remainders are the same as in Example 1.

### Example 5

Support portions formed by outward folding are provided on the two leg portions of the inductor. These support portions are placed against the inner cylinder wall of the cartridge. At this point, the maximum distance between the two leg portions of the inductor is the distance between the end points of the two support portions, which is 7 mm. The longitudinal section of the inductor within the cartridge in this example is shown in FIG. 15b.

As shown in FIG. 15c, in this example, protrusions can further be set on the inductor according to needs. The distance between the end points of the protrusions is preferably the diameter of the inner cylinder of the packaging member, i.e., 7 mm. The remainders is the same as in Example 4.

### Example 6

The packaging member has a length of 55 mm, an outer diameter of 7.5 mm, and a thickness of 1.2 mm. The inner diameter of the packaging member is 6.3 mm. The length of the diversion section is set to 5 mm; the smoke-forming material section is set to 15 mm; the hollow section is set to 15 mm; and the filter tip section is set to 20 mm.

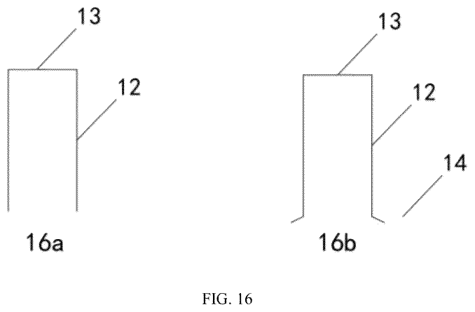

The said inductor is made of continuous cylindrical magnetic conductive material bent twice. The longitudinal section of the said inductor is door-frame shaped. The inductor is 14 mm high. The maximum distance between the two leg portions of the inductor is 3.15 mm. The longitudinal section of the inductor within the cartridge in this example is shown in FIG. 16a. For the installation of the inductor with the “door-frame” shape in the cartridge, as shown in FIG. 16a, it is required to load the smoke-forming material while withdrawing the insertion rod simultaneously. To better support the inductor, support portions can be formed at the ends of the leg portions of the inductor by folding, as shown in FIG. 16b. The distance between the outer ends of the two support portions is 6.3 mm.

In this example, the first separation material is made of perforated aluminum foil paper, and the second separation material is made of perforated paper. The first separation material is cut from perforated aluminum foil paper into a shape with multiple sharp angles as shown in FIG. 22d. The part with angles is the outer ring mating portion. These angles are not completely cut to the inner ring sealing portion. The second separation material is cut to form a shape with multiple sharp angles as shown in FIG. 22g. The part with the sharp angles is the outer ring mating portion. These angles are completely cut to the inner ring sealing portion, so that there is no continuous connection between the adjacent shape angles.

In this example, the first separation material is set in the packaging member by the attaching method, and the second separation material is set in the packaging member by the gluing method. The transverse section of the first separation material after being pushed into the packaging member with an insertion rod is shown in FIG. 23d; the transverse section of the second separation material after being pushed into the cartridge with a push rod is shown in FIG. 23a. The remainders are the same as in Example 1.

### Example 7

The packaging member has a length of 50 mm, an outer diameter of 6.6 mm, and a thickness of 0.1 mm. The inner diameter of the packaging member is 6.4 mm. The length of the diversion section is set to 5 mm; the smoke-forming material section is set to 15 mm; the hollow section is set to 12 mm; and the filter tip section is set to 18 mm.

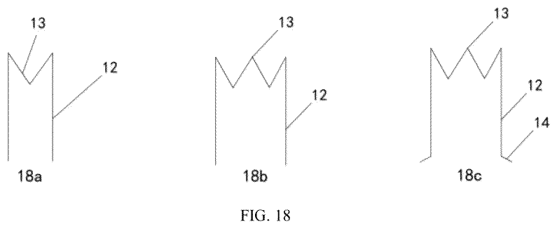

The said inductor is made of continuous magnetic conductive material bent an odd number of times, with the odd number being 3. As shown in FIG. 18a, the longitudinal section of the said end is serration-shaped, while the longitudinal section of the leg portions is “II” shaped. The height of the inductor is 14 mm, and the maximum distance between the two leg portions of the inductor is 3.2 mm. In the case of using the inductor shown in FIG. 18a in the cartridge, it is required to load the smoke-forming material while withdrawing the insertion rod simultaneously. Therefore, an insertion rod with positioning function is required for such loading.

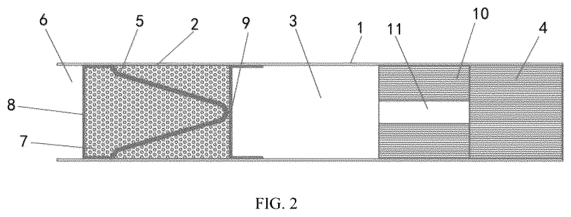

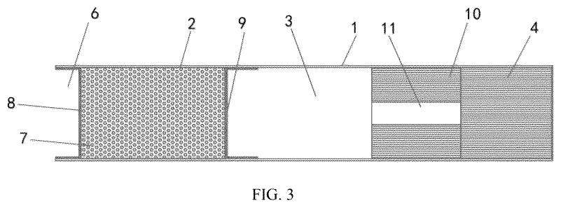

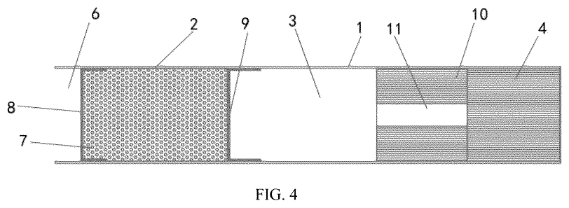

In this example, both the first and second separation materials are made of perforated silicone films, as shown in FIG. 2. In this example, the longitudinal section of the first separation material is “]” shaped, and the longitudinal section of the second separation material is “[” shaped. As shown in FIG. 22e, the outer ring mating portions on the first and second separation materials are cut into multiple continuous trapezoids, and adjacent trapezoids are not connected together, forming a shape similar to gears. The said first and second separation materials, after being pushed into the cartridge with an insertion rod, have a smooth structure in the transverse section of the packaging member, as shown in FIG. 23a.

The said filter tip section is positioned at the proximal end of the packaging member and consists of a combination of a solid core filter road and a hollow filter rod, both made from acetate fibers. The length of the solid core filter rod is 10 mm, and the length of the hollow filter rod is 8 mm. The total transverse section area of the aerosol passage in the hollow filter rod is 50% of the total transverse section area of the packaging member. The hollow filter rod is positioned on one side of the filter tip section near the hollow section. Due to the aerosol passage in the hollow filter rod, the smoke undergoes the Venturi effect as it passes through the aerosol passage in the filter tip section, rapidly reducing its temperature. The cooled smoke then enters the solid core filter rod for further cooling and filtration before being inhaled by the user, so that the user experiences no sensation of heat on the lips during inhalation. The remainders are the same as in Example 1.

### Example 8

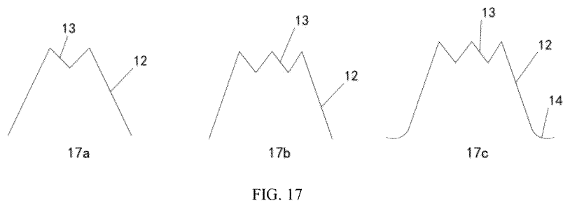

The longitudinal sections of the leg portions is “ [symbol] ” (Chinese character “eight”)-shaped. The maximum distance between the two leg portions on the inductor is 6.4 mm. The longitudinal section of the inductor within the cartridge in this example is shown in FIG. 17a. The remainders are the same as in Example 7.

### Example 9

The said inductor is made of continuous magnetic conductive material bent an odd number of times, with the odd number being 5, forming a longitudinal section as shown in FIG. 17b. When the maximum distance between the two leg portions on the inductor in this example is less than 6.4 mm, support portions can be set up as needed. These support portions are formed by bending or folding outward from the ends of the two leg portions towards the opening direction of the inductor; the outermost ends of the two support portions are placed against the inner cylinder wall of the packaging member. The specific structure is shown in FIG. 17c. The remainders are the same as in Example 8.

### Example 10

The said inductor is made of continuous magnetic conductive material bent an odd number of times, with the odd number being 5, forming a longitudinal section as shown in FIG. 18b. When the maximum distance between the two leg portions on the inductor in this example is less than 6.4 mm, support portions can be set up as needed. These support portions are formed by bending or folding outward from the ends of the two leg portions towards the opening direction of the inductor; the outermost ends of the two support portions are placed against the inner cylinder wall of the packaging member. The specific structure is shown in FIG. 18c. The remainders are the same as in Example 7.

### Example 11

The packaging member has a length of 41 mm, an outer diameter of 6.6 mm, and a thickness of 0.1 mm. The inner diameter of the packaging member is 6.4 mm. The length of the diversion section is set to 1 mm; the smoke-forming material section is set to 15 mm; the hollow section is set to 10 mm; and the filter tip section is set to 20 mm.

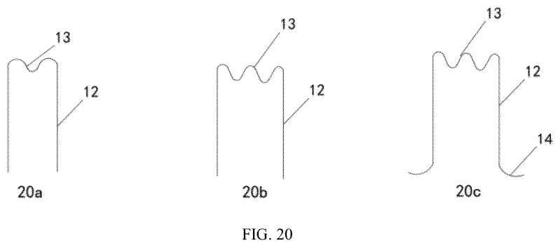

The said inductor is made of continuous magnetic conductive material bent an odd number of times, with the odd number being 3. The said longitudinal section of the end portion is wave-shaped, and the longitudinal sections of the leg portions “II” shaped. The height of the inductor is 12 mm, and the maximum distance between the two leg portions of the inductor is 3.2 mm. The longitudinal section of the inductor within the cartridge in this example is shown in FIG. 20a.

In this example, both the first and second separation materials are made of perforated gel films, as shown in FIG. 2. In this example, the longitudinal section of the first separation material is “]” shaped, and the longitudinal section of the second separation material is “[” shaped. As shown in FIG. 22f, the outer ring mating portions on the first and second separation materials are cut into multiple continuous trapezoids, and adjacent trapezoids are connected together, forming a shape similar to gears. The transverse sections of the first and second separation materials within the packaging member after being pushed in by an insertion rod are shown in FIG. 23d. The outer ring mating portion form wrinkles after being squeezed. The remainders are the same as in Example 1.

### Example 12

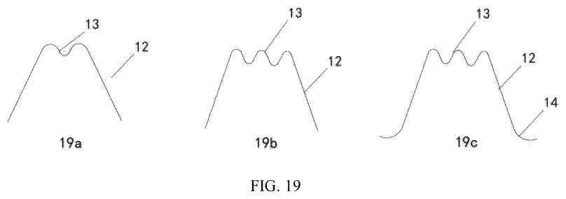

The longitudinal sections of the leg portions is “ [symbol] ” (Chinese character “eight”)-shaped. The maximum distance between the two leg portions on the inductor is 6.4 mm. The longitudinal section of the inductor within the cartridge in this example is shown in FIG. 19a. The remainders are the same as in Example 11.

### Example 13

The said inductor is made of continuous magnetic conductive material bent an odd number of times, with the odd number being 5. The inductor of this structure is shown in FIG. 20b. When the maximum distance between the two leg portions on the inductor in this example is less than 6.4 mm, support portions can be set up as needed. These support portions are formed by bending or folding outward from the ends of the two leg portions towards the opening direction of the inductor; the outermost ends of the two support portions are placed against the inner cylinder wall of the packaging member. The specific structure is shown in FIG. 20c. The remainders are the same as in Example 11.

### Example 14

The said inductor is made of continuous magnetic conductive material bent five times. The inductor fabricated is shown in FIG. 19b. When the maximum distance between the two leg portions on the inductor in this example is less than 6.4 mm, support portions can be set up as needed. These support portions are formed by bending or folding outward from the ends of the two leg portions towards the opening direction of the inductor; the outermost ends of the two support portions are placed against the inner cylinder wall of the packaging member. The specific structure is shown in FIG. 19c. The remainders are the same as in Example 12.

### Example 15

The packaging member has a length of 60 mm, an outer diameter of 8 mm, and a thickness of 0.05 mm. The inner diameter of the packaging member is 7.95 mm. The length of the diversion section is set to 5 mm; the smoke-forming material section is set to 20 mm; the hollow section is set to 15 mm; and the filter tip section is set to 20 mm.

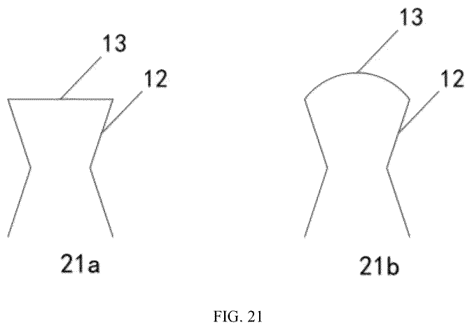

The said inductor is made of continuous magnetic conductive material folded four times. The said magnetic conductive material is a cobalt-based high-temperature alloy, and has a width of 3.6 mm and a thickness of 0.096 mm. The longitudinal section of the said inductor is shown in FIG. 21a. The end of the formed inductor is smooth in structure, with leg portions shaped as “><”. The height of the inductor is 18 mm, with the minimum distance between the two leg portions being 2 mm, and the maximum distance between the two leg portions being 7.95 mm. In this example, the inductor can also be bent once at its ends to form an arc shape according to needs, thereby forming a structure as shown in FIG. 21b. The remainders are the same as in Example 1.

### Example 16

In the second separation material described in the above examples 1-16, when it is pushed into the packaging member and attached or glued in the predetermined position, several grooves can be arranged along the axial direction on the surface of the insertion rod. The grooves on the insertion rod have a certain angle and the depth of the grooves on the axial direction of the insertion rod is gradually varied. The grooves at the end of the insertion rod are the deepest, and the grooves in the middle of the insertion rod are the shallowest.

During the process of pushing the second separation material into the packaging member, the excess part of the outer ring mating portion would originally form wrinkles. However, due to the presence of grooves, the excess part will enter the grooves under extrusion force, thereby causing the outer ring mating portion to form indentations between the outer ring mating portion and the inner cylinder wall of the packaging member, as shown in FIG. 23e. In the case of using either the attaching or gluing method, these indentations remain. The formed indentations can serve as pathways for airflow, regulating suction resistance and increasing air permeability. They can also help avoid or reduce perforation on the flexible sheet material constituting the second separation material.

### Example 17

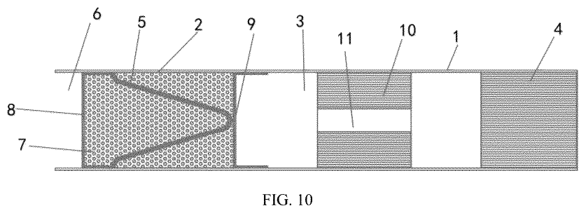

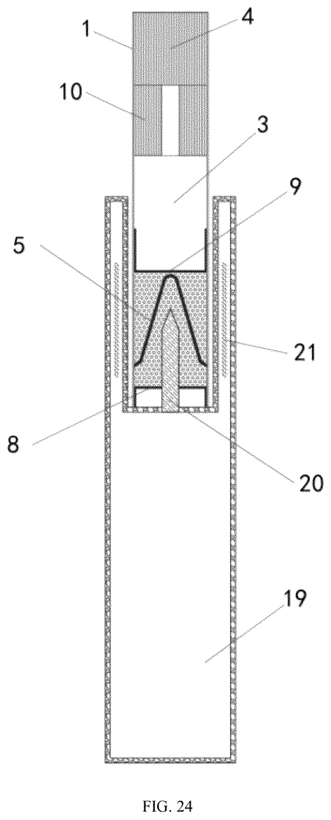

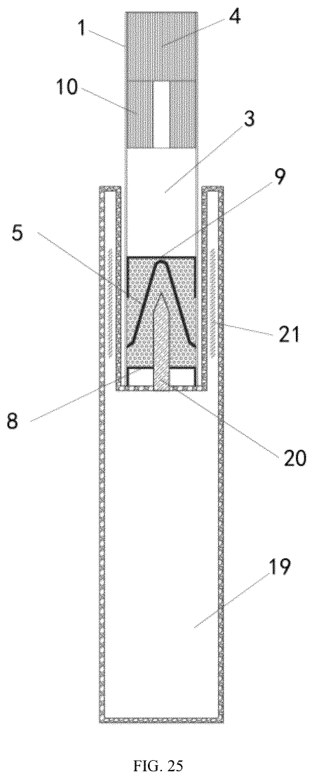

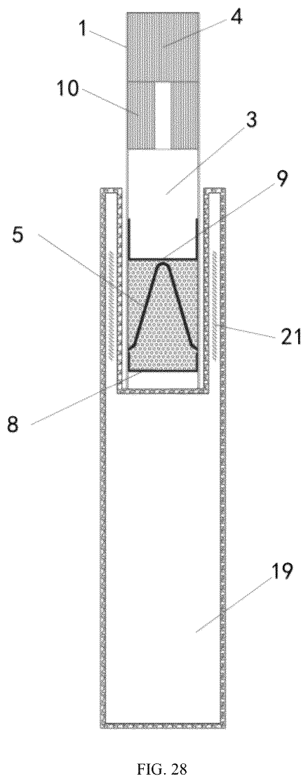

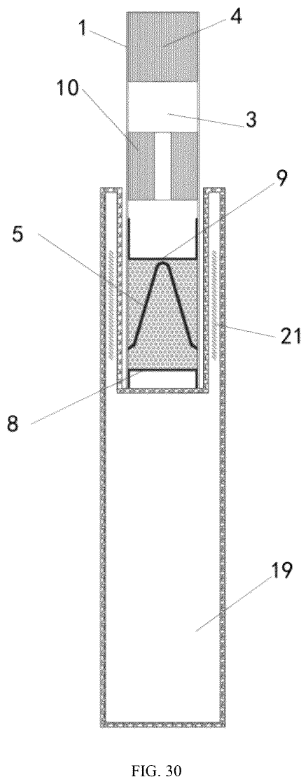

The orientation of the inductor in the cartridge in the above examples 1-16 is as follows: as shown in FIGS. 1, 2, 5, and 10, the ends of the leg portions of the inductor are oriented towards the first separation material, and the end portion of the inductor is oriented towards the second separation material. As shown in FIGS. 24, 25, 28, and 30, the cartridge of this structure adapts to both resistive or electromagnetic plug-in central heating smoking devices and resistive or electromagnetic circumferential heating smoking devices. When using a plug-in heater, the opening between the two leg portions of the inductor can accommodate heating needles or heating plates inserted into the smoke-forming product. In this case, the inductor acts as a heat transfer medium, ensuring that heat is evenly distributed to all corners of the smoke-forming product section. When using a circumferential heater, the inductor acts as a heater to provide heat to the smoke-forming product, while ensuring that the heat generated is evenly transmitted to the smoke-forming product, thereby improving heating efficiency.

### Example 18

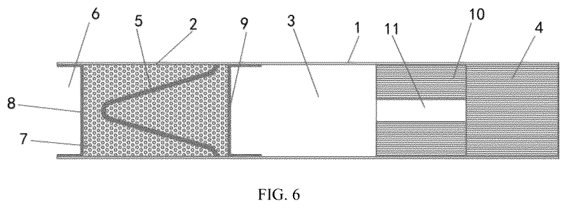

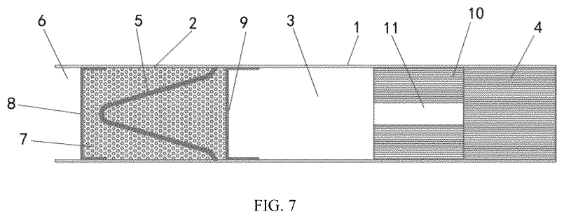

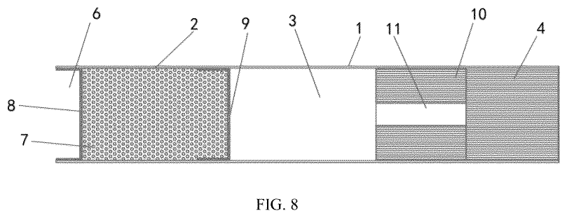

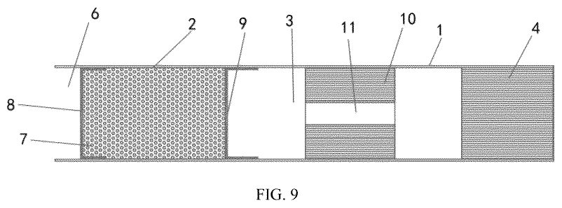

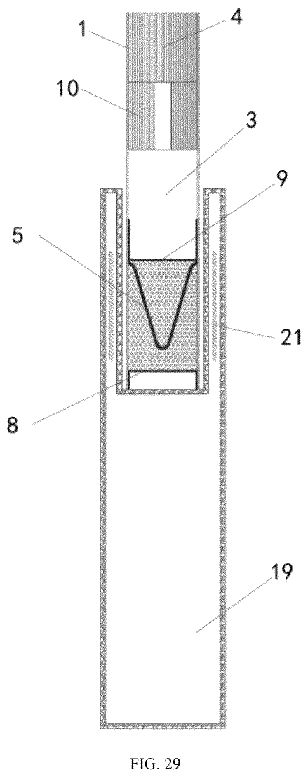

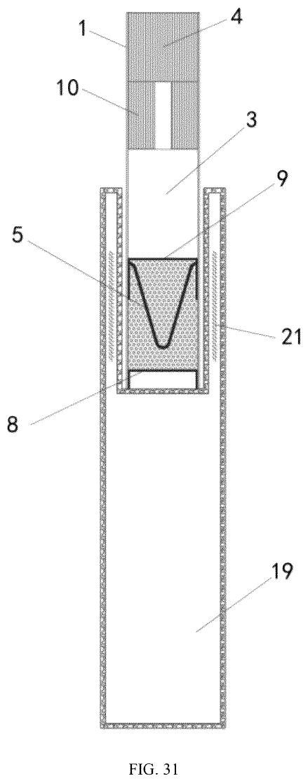

The orientation of the inductor in the cartridge in the above examples 1-16 is as follows: as shown in FIGS. 6 and 7, the end portion of the inductor are oriented towards the first separation material, and the ends of the leg portions of the inductor is oriented towards the second separation material. As shown in FIGS. 29 and 31, the cartridge of this structure is exclusively used for resistive or electromagnetic circumferential heating smoking devices. The inductor acts as a heater to provide heat to the smoke-forming product, while ensuring that the heat generated is evenly transmitted to the smoke-forming product, thereby improving heating efficiency.

### Example 19

An inductor for e-cigarette cartridges, characterized in that the said inductor is produced through the following steps:
(1) Select a continuous iron-nickel alloy as the magnetic conductive material. Then Process the material to into a sheet material with width of 4 mm and a thickness of 0.2 mm.
(2) Cut the continuous magnetic conductive material into 2.5 times the length of the smoke-forming base section.
(3) Place the cut magnetic conductive material into a mold and forming the predetermined shape of the inductor by folding once; the said inductor has one end portion and two leg portions, with one closed end of the inductor being the end portion and the two open side-portions being the leg portions. The fabricated inductor is shown in FIG. 13a.
(4) The ends of the two leg portions of the inductor fabricated can also be bent or folded outward to the opening of the inductor to form support portions, as shown in FIG. 13b.

The said inductor is loaded into the packaging member of the cartridge using a loading device, and the part with the maximum width between the two leg portions or the two support portions of the inductor is wedged against the inner cylinder wall of the packaging member, and then smoke-forming base material is loaded into the packaging member to surround the inductor. The preferred loading device is a push-in type loading device, and during loading, it can be inserted from either the distal end or the proximal end.

### Example 20

Select continuous austenitic steel as the magnetic conductive material. Then the material is processed into a sheet material with a width of 2 mm and a thickness of 0.05 mm. The continuous magnetic conductive material is then cut into three times the length of the smoke-forming base section. The cut magnetic conductive material is placed in a mold and bent once into a predetermined shape of the inductor. The said inductor thus obtained has one end portion and two leg portions. The closed end of the inductor is the end portion, while the two open-side portions are the leg portions. The fabricated inductor is as shown in FIG. 14a.

The ends of the two leg portions of the inductor fabricated can also be bent or folded outward to the opening of the inductor to form support portions, as shown in FIG. 14b.

For the angle between the two leg portions and the support portions of the inductor, an R angle can also be applied to form an arc. The effect after processing is shown in FIG. 14c.

Regardless of whether support portions are provided, protrusions can be formed on the two leg portions of the fabricated inductor by bending them outward. The structure of the inductor with protrusions is shown in FIG. 14d.

The said inductor is loaded into the packaging member of the cartridge using a loading device, and the part with the maximum width between the two leg portions, two support portions, or two protrusions of the inductor is wedged against the inner cylinder wall of the packaging member, and then smoke-forming base material is loaded into the packaging member to surround the inductor. The preferred loading device is a push-in type loading device, and during loading, it can be inserted from either the distal end or the proximal end.

### Example 21

Select continuous tungsten-cobalt alloy as the magnetic conductive material. Then the material is processed into a cylindrical material with diameter of 0.15 mm. The continuous magnetic conductive material is then cut into four times the length of the smoke-forming base section. The cut magnetic conductive material is placed in a mold and folded five times into a predetermined shape of the inductor. The said inductor thus obtained has one end portion and two leg portions. The closed end of the inductor is the end portion, while the two open-side portions are the leg portions. The fabricated inductor is as shown in FIG. 17b.

The ends of the two leg portions of the fabricated inductor can also be bent or folded outward to the opening of the inductor to form support portions. For the angle between the two leg portions and the support portions of the inductor, an R angle can also be applied to form an arc. The effect after processing is shown in FIG. 17c.

The said inductor is loaded into the packaging member of the cartridge using a loading device, and the part with the maximum width between the two leg portions or the two support portions of the inductor is wedged against the inner cylinder wall of the packaging member, and then smoke-forming base material is loaded into the packaging member to surround the inductor. The preferred loading device is a push-in type loading device, and during loading, it can be inserted from either the distal end or the proximal end.

### Example 22

An e-cigarette cartridge composed of a diversion section, a smoke-forming base section, a hollow section, and a filter tip section that are sequentially arranged in a packaging member, characterized by the following: The length of the packaging member is 50 mm, the outer diameter of the packaging member is 8 mm, and the thickness of the packaging member is 0.5 mm. Therefore, the inner diameter of the packaging member can be calculated as 7.5 mm. The packaging member is prefabricated by a rolling machine. A piece of tipping paper of the same length as the packaging member may be used to wrap around the outer cylinder wall of the packaging member to enhance aesthetics or to display product information.

The said diversion section is positioned at the far end of the packaging member and is formed by the inner cylinder wall of the packaging member and the first separation material. It serves to create a certain space between the far end of the cartridge and the interior surface of the smoking device to facilitate airflow, preventing tightness between the far end of the cartridge and the internal surface of the device, which could cause excessive suction resistance. Optionally, several ventilation holes may be set through the cylindrical wall of the diversion section to further reduce suction resistance and provide multiple airflow paths. The length of the diversion section in the cartridge is 2 mm.

The said first separation material is glued to the inner cylinder wall of the packaging member, separating the diversion section from the smoke-forming base section. It not only separates the diversion section from the smoke-forming base section but also acts as a barrier or seal for the smoke-forming base section to prevent it from falling off. Additionally, it features tiny air holes to provide air passage. The thickness of the first separation material ranges from 1.05 μm.

The said smoke-forming base section is filled with smoke-forming base material, wherein the smoke-forming material consists of particles made from tobacco and/or non-tobacco plants. The said tobacco particles are obtained by grinding and pelletizing flue-cured, air-dried, sun-dried, burley, and other flavored tobacco leaves or tobacco shreds. The length of the smoke-forming base section is 15 mm.

The hollow section is surrounded by the second separation material, the inner cylinder wall of the packaging member, and the filter tip section. The main function of the hollow section is cooling. Fragrance-enhancing particles can also be added to the hollow section. The length of the hollow section in the cartridge is 13 mm. Fragrance-enhancing particles are particles made directly from flavorings/fragrances or other particles containing aromatic ingredients.

The said second separation material is attached to the inner cylinder wall of the packaging member and separates the hollow section from the smoke-forming base section. This configuration prevents the smoke-forming material from entering the hollow section, thereby encapsulating or sealing the smoke-forming base material. In designing the loading method, because the second separation material is not sealed to the inner cylinder wall of the packaging member, air holes may not be necessary on the second separation material, and instead, high-permeability shaped paper alone may suffice to provide air passage. The thickness of the second separation material is 1.05 μm.

The said first separation material is perforated paper. The second separation material is high-permeability shaped paper (20000CU), and the longitudinal sections of both the first and second separation materials are “]” shaped.

The said filter section is made of materials capable of filtering and cooling smoke, and is positioned at the proximal end of the packaging member. The filter tip section consists of a combination of a solid-core filter rod and a hollow filter rod. The length of the solid filter rod is 11 mm. The length of the hollow filter rod is 9 mm. The hollow filter rod and the solid core filter rod may be tightly connected or disconnected. At least one aerosol passage is provided on the hollow filter rod, and the total transverse section area of the aerosol passages is 30% of the total transverse section area of the packaging member.

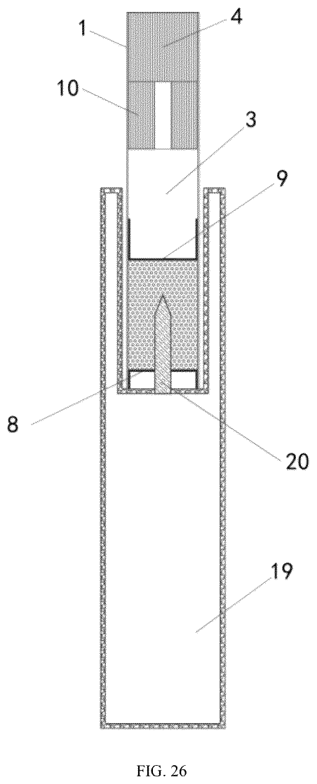

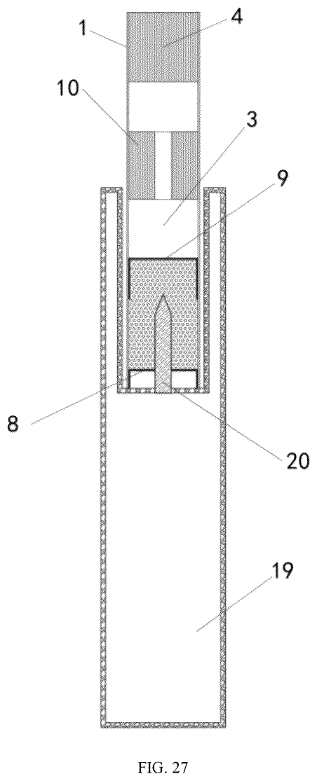

Since no inductor is set, the cartridge in this example can only be used for resistive or electromagnetic plug-in central heating smoking devices. Specific usages are shown in FIGS. 26 and 27.

### Example 23

The said smoke-forming base section has an inductor which is formed into a closed geometric structure by bending or folding continuous sheet-like or cylindrical magnetic conductive material; and the said inductor is placed within the smoke-forming base section and surrounded by it. The remainders are the same as in Example 23.

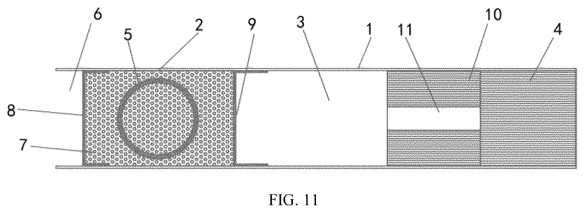

The said inductor is placed within the smoke-forming base section and surrounded by it. The said geometric structure can be circular, elliptical, rectangular, triangular, or other irregular closed loop structures. Since the inductor is a closed geometric structure, it can also be prefabricated in one step using a mold. In this example, a circular geometric structure is chosen for the inductor, as shown in FIG. 11.

The inductor in this example is fabricated using the following method:

Select a continuous sheet or cylindrical magnetic conductive material, and determine the width and thickness of the sheet magnetic conductive material or the diameter of the cylindrical magnetic conductive material to meet the requirements; if the material does not meet the requirements, then the material is processed to meet the requirements. Specifically, the said sheet magnetic conductive material is required to be 0.5-4 mm wide, and 0.01-0.2 mm thick, and the cylindrical magnetic conductive material is required to have a diameter ranging from 0.05 to 2 mm.

In the case of using a sheet magnetic conductive material, the width of the magnetic conductive material can smoothly vary within a certain range, so that the two long sides of the magnetic conductive material form continuous serrations, waves, or gear shapes. Multiple arc-shaped or rectangular grooves can also be evenly set on both long sides of the magnetic conductive material.

In the case of using a cylindrical magnetic conductive material, continuous thread-like shapes can be formed on the surface of the magnetic conductive material by cutting, or multiple arc-shaped or rectangular grooves can be set on the magnetic conductive material.

Cut the continuous magnetic conductive material into preset lengths; the preset length is determined according to the length of the smoke-forming base section used, generally 1.5-4 times the length of the smoke-forming base material section.

Place the cut magnetic conductive material into a mold and form the desired shape of the inductor through folding and/or bending. Then the ends of the magnetic conductive material of the fabricated inductor are tightly joined together to create a closed geometric shape.

During usage, the fabricated inductor is loaded into the packaging member of the cartridge via a loading device, followed by filling the packaging member with smoke-forming material so that the inductor is entirely surrounded by the smoke-forming material. The loading device preferably is a push-in type, allowing insertion either from the far end or the proximal end. The said push-in loading device ensures that the inductor does not deform during the loading process.

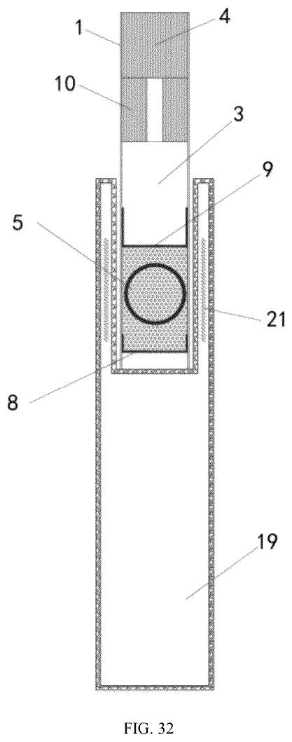

With the inductor provided, as shown in FIG. 32, the cartridge of this structure can be used for electromagnetic circumferential heating smoking devices. Since the inductor is designed as a closed geometric structure, heating needles or plates cannot be inserted into the cartridges in resistive or electromagnetic plug-in central heating smoking devices. Therefore, this type of cartridge structure is only suitable for circumferential heating devices and not for plug-in heating devices.

### Example 24

Both the said first separation material and the second separation material include an inner ring sealing portion and an outer ring mating portion, wherein the said inner ring sealing portion and the said outer ring mating portion are different components of a single flexible sheet material. The said inner ring sealing portion is the central portion of the single flexible sheet material and is circular and the diameter of the inner ring sealing portion=the inner diameter of the packaging member; the outer ring mating portion is the portion of the single flexible sheet material other than the inner ring sealing portion.

The said outer ring mating portion, before being folding, undergoes trimming to either integrally connect to the circumference of the inner ring sealing portion, forming a circular shape, continuous serrations, continuous waves, or continuous gears; or partially connect to the circumference of the inner ring sealing portion, forming multiple discontinuous protrusions.

When the outer ring mating portion is entirely connected to the circumference of the inner ring sealing portion, forming a ring, it presents a wrinkled shape after the first or second separation materials are pushed in by the insertion rod and tightly attached or glued to the inner cylinder wall of the packaging member.

When the outer ring mating portion is entirely connected along the circumference of the inner ring sealing portion, and presents continuous serrate, wave, or gear shapes, the first or second separation material may appear wrinkled or smooth after being pushed in and tightly attached or glued to the inner cylinder wall of the packaging member. This depends on the size of the trimmed part.

When the outer ring mating portion is partially connected to the circumference of the inner ring sealing portion, forming multiple discontinuous protrusions, it presents a smooth appearance after the first or second separation materials are pushed in by the insertion rod and tightly attached or glued to the inner cylinder wall of the packaging member.

The remainders are the same as in Example 23.

What is claimed is:

1. An e-cigarette cartridge composed of a diversion section, a smoke-forming base section, a hollow section, and a filter tip section that are sequentially arranged in a packaging member, characterized by the following:
The said packaging member is a hollow paper cylinder;
The said diversion section is set on a far end of the packaging member, and the diversion section consists of an inner cylinder wall of the packaging member and a first separation material; the said first separation material is attached or glued to the inner cylinder wall of the packaging member and separates the diversion section from the smoke-forming base section;
The said smoke-forming base section is filled with smoke-forming material and an inductor, with the said smoke-forming material being particles made from tobacco and/or non-tobacco plants, and the said inductor being made by bending or folding continuous sheet or cylindrical magnetic conductive material at least once, forming a partially enclosed geometric shape in the longitudinal section of the e-cigarette; the inductor has one end portion and two leg portions; the closed end of the inductor is the end portion, and the two open side-portions are the leg portions;
The said inductor is placed within the smoke-forming base section and surrounded by it;
The hollow section is formed by a second separation material, the inner cylinder wall of the packaging member, and the filter tip section, with the said second separation material attached or glued to the inner cylinder wall of the packaging member and separates the diversion section from the smoke-forming base section;
The filter tip section is positioned at the proximal end of the packaging member and made of a material capable of filtering and cooling smoke;
Both the said first separation material and the second separation material are made of flexible sheet materials, and the longitudinal sections of the both is either “]” shaped or “[” shaped.

2. The e-cigarette cartridge according to claim 1, characterized in that the inductor is made by bending continuous magnetic conductive material once along a predetermined folding line, with the said folding line set at half the length of the magnetic conductive material in the longitudinal direction, resulting in a longitudinal section of the inductor shaped like “>” after folding.

3. The e-cigarette cartridge according to claim 1, characterized in that the inductor is made by bending continuous magnetic conductive material once, with the longitudinal section of the inductor shaped like “U”.

4. The e-cigarette cartridge according to claim 1, characterized in that the inductor is made by bending continuous magnetic conductive material once, resulting in a longitudinal section of the inductor forming an arc open on one side, with the arc having a radius of
$$π - \frac{11}{6} π ,$$
and a diameter ranging from 50% to 100% of the inner diameter of the packaging member.

5. The e-cigarette cartridge according to claim 1, characterized in that the inductor is made by bending continuous magnetic conductive material twice, resulting in a longitudinal section of the inductor shaped like a door frame.

6. The e-cigarette cartridge according to claim 1, characterized in that the inductor is made by bending continuous magnetic conductive material an odd number of times, where the odd number is ≥3; the longitudinal section of the said end portion is serrate-shaped or wave-shaped, and the longitudinal sections of the leg portions is “ [symbol] ” (Chinese character “eight”)-shaped or “II”-shaped.

7. The e-cigarette cartridge according to any of claims 3 and 4, characterized in that protrusions formed by outward bending or folding are set on the two leg portions of the inductor, and said protrusions are supported on the inner cylinder wall of the packaging member.

8. The e-cigarette cartridge according to claim 7, characterized in that support portions are also provided on the inductor, with the said support portions being formed by outward bending or folding of the ends of the two leg portions towards the opening of the inductor; the outermost ends of the two support portions are supported on the inner cylinder wall of the packaging member.

9. The e-cigarette cartridge according to any of claims 2 to 6, characterized in that the height of the inductor is ≤the length of the smoke-forming base section, and the maximum distance between the two leg portions on the inductor is ≤the inner diameter of the packaging member.

10. The e-cigarette cartridge according to claim 9, characterized in that support portions are also provided on the inductor, with the said support portions being formed by outward bending or folding of the ends of the two leg portions towards the opening of the inductor; the outermost ends of the two support portions are supported on the inner cylinder wall of the packaging member.

11. The e-cigarette cartridge according to claim 1, characterized in that the first separation material and the second separation material each comprise an inner ring sealing portion and an outer ring mating portion, wherein the said inner ring sealing portion and the said outer ring mating portion are different components of a single flexible sheet material; the said inner ring sealing portion is the central portion of the single flexible sheet material and is circular, and the diameter of the inner ring sealing portion=the inner diameter of the packaging member; the outer ring mating portion is the portion of the single flexible sheet material other than the inner ring sealing portion; the flexible sheet material is high-permeability shaped paper (3000CU-20000CU), perforated paper, perforated aluminum foil, perforated aluminum foil paper, perforated heat-resistant plastic film, perforated silicone film, perforated gel film, or perforated polylactic acid film.

12. The e-cigarette cartridge according to claim 11, characterized in that the outer ring mating portion, placed beyond the circumference of the inner ring sealing portion, is tightly attached or glued to the inner cylinder wall of the packaging member after being folded, presenting a smooth or wrinkled shape.

13. The e-cigarette cartridge according to claim 12, characterized in that the said outer ring mating portion, before being folding, undergoes trimming to either entirely connect to the circumference of the inner ring sealing portion, forming a circular shape, continuous serrations, continuous waves, or continuous gears; or partially connect to the circumference of the inner ring sealing portion, forming multiple discontinuous protrusions.

14. The e-cigarette cartridge according to claim 11, characterized in that the second separation material is pushed into the packaging member by a cylindrical insertion rod and attached or glued to in a predetermined position, wherein the surface of the said cylindrical insertion rod has several grooves arranged in the axial direction and the said outer ring mating portion forms indentations between the inner cylinder wall of the packaging member under the effect of the grooves.

15. The e-cigarette cartridge according to claim 9, characterized in that the ends of the said leg portions are oriented towards the first separation material, and the said end portion is oriented towards the second separation material.

16. The e-cigarette cartridge according to claim 9, characterized in that the said end portion is oriented towards the first separation material, and the ends of the said leg portions are oriented towards the second separation material.

17. The e-cigarette cartridge according to claim 1, characterized in that the filter tip section consists solely of a solid-core filter rod, or is composed of a combination of a solid-core filter rod and a hollow filter rod, wherein the hollow filter rod and the solid core filter rod may be tightly connected or disconnected; at least one aerosol passage is provided on the hollow filter rod, and the total transverse section area of the aerosol passages is 30%-90% of the total transverse section area of the packaging member.

18. The e-cigarette cartridge according to claim 1, characterized in that the magnetic conductive material, specifically ferromagnetic or paramagnetic metals or metal alloys, is capable of converting electromagnetic energy into heat, wherein said sheet magnetic conductive material is 0.5-4 mm wide and 0.01-0.2 mm thick, and the diameter of the cylindrical magnetic conductive material is 0.05-2 mm.

19. An inductor for e-cigarette cartridges, characterized in that the said inductor is produced through the following steps:
Selecting continuous sheet or cylindrical magnetic conductive material and determining the width and thickness of the sheet material or the diameter of the cylindrical material according to requirements;
Cutting the continuous magnetic conductive material into predetermined lengths;
Placing the cut magnetic conductive material into a mold and forming the predetermined shape of the inductor through folding and/or bending at least once; the said inductor has one end portion and two leg portions, with one closed end of the inductor being the end portion and the two open side-portions being the leg portions.

20. The inductor for e-cigarette cartridges according to claim 19, characterized in that the end of the two leg portions are bent or folded outward toward the opening of the inductor to form support portions, or protrusions formed by outward bending or folding, toward the opening of the inductor, are further provided on the two leg portions of the inductor.

21. The inductor for e-cigarette cartridges according to claim 19 or claim 20, characterized in that during filling, the inductor is loaded into the packaging member of the cartridge using a loading device, and the part with the maximum width between the two leg portions, two support portions, or two protrusions of the inductor is wedged against the inner cylinder wall of the packaging member, and then smoke-forming base material is loaded into the packaging member to surround the inductor.

22. An e-cigarette cartridge composed of a diversion section, a smoke-forming base section, a hollow section, and a filter tip section that are sequentially arranged in a packaging member, characterized by the following:
The said packaging member is a hollow paper cylinder;
The said diversion section is set on a far end of the packaging member, and the diversion section consists of an inner cylinder wall of the packaging member and a first separation material; the said first separation material is attached or glued to the inner cylinder wall of the packaging member and separates the diversion section from the smoke-forming base section;
The said smoke-forming base section is filled with smoke-forming base material, wherein the smoke-forming material consists of particles made from tobacco and/or non-tobacco plants;
The hollow section is formed by a second separation material, the inner cylinder wall of the packaging member, and the filter tip section, with the said second separation material attached or glued to the inner cylinder wall of the packaging member and separates the diversion section from the smoke-forming base section;
The said filter section is made of materials capable of filtering and cooling smoke, and is positioned at the proximal end of the packaging member; the filter tip section consists solely of a solid-core filter rod, or is composed of a combination of a solid-core filter rod and a hollow filter rod, wherein the hollow filter rod and the solid core filter rod may be tightly connected or disconnected; at least one aerosol passage is provided on the hollow filter rod, and the total transverse section area of the aerosol passages is 30%-90% of the total transverse section area of the packaging member;
Both the said first separation material and the second separation material are made of flexible sheet materials, and the longitudinal sections of the both is either “]” shaped or “[” shaped.

23. The e-cigarette cartridge as claimed in claim 22, characterized in that the said smoke-forming base section has an inductor which is formed into a closed geometric structure by bending or folding continuous sheet-like or cylindrical magnetic conductive material; and the said inductor is placed within the smoke-forming base section and surrounded by it.

24. The e-cigarette cartridge according to claim 22, characterized in that the first separation material and the second separation material each comprise an inner ring sealing portion and an outer ring mating portion, wherein the said inner ring sealing portion and the said outer ring mating portion are different components of a single flexible sheet material; the said inner ring sealing portion is the central portion of the single flexible sheet material and is circular, and the diameter of the inner ring sealing portion=the inner diameter of the packaging member; the outer ring mating portion is the portion of the single flexible sheet material other than the inner ring sealing portion; the flexible sheet material is high-permeability shaped paper (3000CU-20000CU), perforated paper, perforated aluminum foil, perforated aluminum foil paper, perforated heat-resistant plastic film, perforated silicone film, perforated gel film, or perforated polylactic acid film.
